(19) United States
(12) Patent Application Publication
(10) Pub. No.: US 2025/0039956 A1
(43) Pub. Date: Jan. 30, 2025

(54) CONTROL PLANE OPERATION FOR DISAGGREGATED RADIO ACCESS NETWORK

(71) Applicant: QUALCOMM INCORPORATED, San Diego, CA (US)

(72) Inventors: Jianhua Liu, Beijing (CN); Gavin Bernard Horn, La Jolla, CA (US); Peng Cheng, Beijing (CN); Ozcan Ozturk, San Diego, CA (US); Aziz Gholmieh, Del Mar, CA (US); Rajat Prakash, San Diego, CA (US); Karthika Paladugu, Hyderabad (IN)

(21) Appl. No.: 18/715,673

(22) PCT Filed: Jan. 25, 2022
(86) PCT No.: PCT/CN2022/073635

§ 371 Date: May 31, 2024

(51) Int. Cl. H04W 76/10; H04W 24/02; H04W 24/08; H04W 68/02

(52) U.S. Cl. CPC H04W 76/10; H04W 24/02; H04W 24/08; H04W 68/02

(57) ABSTRACT

Methods, systems, and devices for wireless communications are described. In one aspect, a user equipment (UE) may be provided with wireless local area network (WLAN) identifiers associated with a public land mobile network (PLMN) for determining WLAN access points that support control plane termination at a fifth generation (5G) RAN for the PLMN. In another aspect, a network node may encapsulate system information in a broadcast message for transmission from a WLAN access point to a UE, and the UE may be configured to receive the system information from the WLAN access point in one or more modification periods. In yet another aspect, a network node may encapsulate a paging message for a broadcast or unicast transmission from a WLAN access point to a UE. In yet another aspect, UEs and network nodes may be configured to map traffic characteristics of traffic for a 5G bearer to WLAN access categories.

### CROSS REFERENCE

The present Application is a 371 national stage filing of International PCT Application No. PCT/CN2022/073635 by Liu et al. entitled “CONTROL PLANE OPERATION FOR DISAGGREGATED RADIO ACCESS NETWORK,” filed Jan. 25, 2022, which is assigned to the assignee hereof, and which is expressly incorporated by reference in its entirety herein.

### FIELD OF TECHNOLOGY

The following relates to wireless communications, including control plane operation for disaggregated radio access network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a UE may support communications with a network node via one or more radio access technologies (RATs). For example, the UE may communicate over a 5G radio access network (RAN), a wireless local area network (WLAN), or both. Efficient techniques for facilitating communications over the WLAN with control plane termination in the 5G RAN may be desirable.

### SUMMARY

The described techniques relate to improved methods, systems, devices, and apparatuses that support control plane operation for disaggregated radio access network (RAN). In one aspect, a user equipment (UE) may be provided with wireless local area network (WLAN) identifiers associated with a public land mobile network (PLMN) for determining WLAN access points that support control plane termination at a fifth generation (5G) RAN for the PLMN. In another aspect, a network node may encapsulate system information in a broadcast message for transmission from a WLAN access point to a UE, and the UE may be configured to receive the system information from the WLAN access point in one or more modification periods. In yet another aspect, a network node may encapsulate a paging message for a broadcast or unicast transmission from a WLAN access point to a UE. In yet another aspect, UEs and network nodes may be configured to map traffic characteristics of traffic for a 5G bearer to WLAN access categories.

A method for wireless communication is described. The method may include establishing, by a user equipment (UE), a first connection with a node of an operator network via an access point, where the operator network is associated with a first type of wireless communications and the access point is associated with a second type of wireless communications, and where the access point is selected from a set of access points based on the operator network and information associating the operator network with the access point and communicate with the node of the operator network via the access point based on establishing the first connection with the node of the operator network.

An apparatus for wireless communication is described. The apparatus may include a processor, memory coupled with the processor, and instructions stored in the memory. The instructions may be executable by the processor to cause the apparatus to establish, by a UE, a first connection with a node of an operator network via an access point, where the operator network is associated with a first type of wireless communications and the access point is associated with a second type of wireless communications, and where the access point is selected from a set of access points based on the operator network and information associating the operator network with the access point and communicate with the node of the operator network via the access point based on establishing the first connection with the node of the operator network.

Another apparatus for wireless communication is described. The apparatus may include means for establishing, by a UE, a first connection with a node of an operator network via an access point, where the operator network is associated with a first type of wireless communications and the access point is associated with a second type of wireless communications, and where the access point is selected from a set of access points based on the operator network and information associating the operator network with the access point and means for communicate with the node of the operator network via the access point based on establishing the first connection with the node of the operator network.

A non-transitory computer-readable medium storing code for wireless communication is described. The code may include instructions executable by a processor to establish, by a UE, a first connection with a node of an operator network via an access point, where the operator network is associated with a first type of wireless communications and the access point is associated with a second type of wireless communications, and where the access point is selected from a set of access points based on the operator network and information associating the operator network with the access point and communicate with the node of the operator network via the access point based on establishing the first connection with the node of the operator network.

Some examples of the method, apparatuses, and non-transitory computer-readable medium described herein may further include operations, features, means, or instructions for transmitting, from the UE to the access point, an address associated with the node of the operator network for control plane termination for the UE for the first type of wireless communications.

In some examples of the method, apparatuses, and non-transitory computer-readable medium described herein, the UE may be configured with respective sets of identifiers associated with the second type of wireless communications for each of a set of multiple operator networks.

Some examples of the method, apparatuses, and non-transitory computer-readable medium described herein may further include operations, features, means, or instructions for receiving a configuration message from the node of the operator network including at least one updated set of identifiers for the respective sets of identifiers.

In some examples of the method, apparatuses, and non-transitory computer-readable medium described herein, the configuration message may be received from a base station associated with the first type of wireless communications or the access point.

Some examples of the method, apparatuses, and non-transitory computer-readable medium described herein may further include operations, features, means, or instructions for receiving, from the access point, system information associating the operator network and the access point.

Some examples of the method, apparatuses, and non-transitory computer-readable medium described herein may further include operations, features, means, or instructions for establishing the first connection with the node may be based on receiving the system information.

In some examples of the method, apparatuses, and non-transitory computer-readable medium described herein, the system information includes an indicator of a duration for a system information modification period or a starting time for the system information modification period and the method, apparatuses, and non-transitory computer-readable medium may include further operations, features, means, or instructions for monitoring for updated system information from the access point based on the indicator.

In some examples of the method, apparatuses, and non-transitory computer-readable medium described herein, the system information includes an indicator of a modification time for the system information and the method, apparatuses, and non-transitory computer-readable medium may include further operations, features, means, or instructions for monitoring for updated system information from the access point based on the indicator.

Some examples of the method, apparatuses, and non-transitory computer-readable medium described herein may further include operations, features, means, or instructions for receiving second system information from a base station associated with the operator network and establishing a second connection with the base station based on the system information or the second system information.

In some examples of the method, apparatuses, and non-transitory computer-readable medium described herein, establishing the second connection may include operations, features, means, or instructions for selecting one of the system information or the second system information for the second connection based on a link priority for receiving system information.

In some examples of the method, apparatuses, and non-transitory computer-readable medium described herein, establishing the second connection may include operations, features, means, or instructions for overwriting a portion of the system information based on the second system information.

Some examples of the method, apparatuses, and non-transitory computer-readable medium described herein may further include operations, features, means, or instructions for receiving a broadcast message from the access point, the broadcast message including a paging message associated with the first type of wireless communications and responding to the paging message based on decoding the paging message.

In some examples of the method, apparatuses, and non-transitory computer-readable medium described herein, responding to the paging message may include operations, features, means, or instructions for transmitting a packet including an encapsulated paging response message to the node of the operator network via the access point or transmitting a paging response message to a base station associated with the operator network.

Some examples of the method, apparatuses, and non-transitory computer-readable medium described herein may further include operations, features, means, or instructions for determining whether to transmit the packet including the encapsulated paging response message to the access point or to transmit the paging response message to the base station based on an access node priority for responding to the paging message, a link quality of the first connection, a channel quality of a channel between the UE and the base station, or a combination thereof.

Some examples of the method, apparatuses, and non-transitory computer-readable medium described herein may further include operations, features, means, or instructions for establishing a second connection to a base station associated with the operator network, establishing a bearer associated with a traffic characteristic over the second connection, and performing a channel access procedure for a channel associated with the second type of wireless communications for communicating data to the access point via the first connection based on an access category of the second type of wireless communications, the access category determined based on the traffic characteristic and a mapping rule between the traffic characteristic and the access category.

In some examples of the method, apparatuses, and non-transitory computer-readable medium described herein, the traffic characteristic includes information an identifier of the bearer, at least one logical channel associated with the bearer, a quality of service profile of the bearer, an access class of the UE, or an establishment cause of the second connection.

Some examples of the method, apparatuses, and non-transitory computer-readable medium described herein may further include operations, features, means, or instructions for receiving, from the access point, an indicator of one or more operator networks supported by the access point for control plane communications associated with the first type of wireless communications, where connecting to the access point may be based on receiving the indicator of one or more operator networks including the operator network.

A method for wireless communication is described. The method may include encapsulating, by a network node associated with an operator network of a first type of wireless communications, a paging message for a UE configured for communications via the first type of wireless communications and a second type of wireless communications, sending, by the network node, a packet including the encapsulated paging message to an access point associated with the second type of wireless communications, and receiving, by the network node, a paging response message from the UE.

An apparatus for wireless communication is described. The apparatus may include a processor, memory coupled with the processor, and instructions stored in the memory. The instructions may be executable by the processor to cause the apparatus to encapsulating, by a network node associate with an operator network of a first type of wireless communications, a paging message for a UE configured for communications via the first type of wireless communications and a second type of wireless communications, send, by the network node, a packet including the encapsulated paging message to an access point associated with the second type of wireless communications, and receive, by the network node, a paging response message from the UE.

Another apparatus for wireless communication is described. The apparatus may include means for encapsulating, by a network node associated with an operator network of a first type of wireless communications, a paging message for a UE configured for communications via the first type of wireless communications and a second type of wireless communications, means for sending, by the network node, a packet including the encapsulated paging message to an access point associated with the second type of wireless communications, and means for receiving, by the network node, a paging response message from the UE.

A non-transitory computer-readable medium storing code for wireless communication is described. The code may include instructions executable by a processor to encapsulating, by a network node associate with an operator network of a first type of wireless communications, a paging message for a UE configured for communications via the first type of wireless communications and a second type of wireless communications, send, by the network node, a packet including the encapsulated paging message to an access point associated with the second type of wireless communications, and receive, by the network node, a paging response message from the UE.

In some examples of the method, apparatuses, and non-transitory computer-readable medium described herein, encapsulating the paging message may include operations, features, means, or instructions for setting a destination address of the packet to an indicator that indicates to the access point to broadcast the packet.

In some examples of the method, apparatuses, and non-transitory computer-readable medium described herein, encapsulating the paging message may include operations, features, means, or instructions for setting a source address of the packet to an address of the network node.

In some examples of the method, apparatuses, and non-transitory computer-readable medium described herein, encapsulating the paging message may include operations, features, means, or instructions for sending an address of the UE to the access point with the packet.

In some examples of the method, apparatuses, and non-transitory computer-readable medium described herein, encapsulating the paging message may include operations, features, means, or instructions for setting a destination address of the packet to an address of the UE.

In some examples of the method, apparatuses, and non-transitory computer-readable medium described herein, encapsulating the paging message may include operations, features, means, or instructions for obtaining the address of the UE from a core node of the first type of wireless communications or from a stored context associated with the UE.

Some examples of the method, apparatuses, and non-transitory computer-readable medium described herein may further include operations, features, means, or instructions for determining to send the encapsulated paging message to the access point based on a predetermined paging policy, a paging policy received from a core node of the first type of wireless communications, a failure to receive a paging response from the UE after transmitting a prior paging message to the UE over a cell associated with the first type of wireless communications, a category of the UE, comparing a discontinuous reception cycle value associated with the UE and a threshold, a connection state of the UE, a characteristic of a protocol data unit including data associated with a paging request received from the core node, a quality of service of the data associated with the paging request, receiving an address of the UE in the paging request, or a combination thereof.

A method is described. The method may include establishing, by a network node associated with an operator network of a first type of wireless communications, a connection to a UE configured for communications via the first type of wireless communications and a second type of wireless communications, establishing a bearer over the connection, and sending data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

An apparatus is described. The apparatus may include a processor, memory coupled with the processor, and instructions stored in the memory. The instructions may be executable by the processor to cause the apparatus to establish, by a network node associated with an operator network of a first type of wireless communications, a connection to a UE configured for communications via the first type of wireless communications and a second type of wireless communications, establish a bearer over the connection, and send data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

Another apparatus is described. The apparatus may include means for establishing, by a network node associated with an operator network of a first type of wireless communications, a connection to a UE configured for communications via the first type of wireless communications and a second type of wireless communications, means for establishing a bearer over the connection, and means for sending data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

A non-transitory computer-readable medium storing code is described. The code may include instructions executable by a processor to establish, by a network node associated with an operator network of a first type of wireless communications, a connection to a UE configured for communications via the first type of wireless communications and a second type of wireless communications, establish a bearer over the connection, and send data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

In some examples of the method, apparatuses, and non-transitory computer-readable medium described herein, sending the data associated with the bearer to the access point may include operations, features, means, or instructions for mapping the traffic characteristic to the access category for the second type of wireless communications.

In some examples of the method, apparatuses, and non-transitory computer-readable medium described herein, sending the data associated with the bearer to the access point may include operations, features, means, or instructions for encapsulating the data in a packet, where a header of the packet includes the access category.

In some examples of the method, apparatuses, and non-transitory computer-readable medium described herein, sending the data associated with the bearer to the access point may include operations, features, means, or instructions for appending the traffic characteristic to the data associated with the bearer.

In some examples of the method, apparatuses, and non-transitory computer-readable medium described herein, the traffic characteristic includes an identifier of the bearer, at least one logical channel associated with the bearer, a quality of service profile of the bearer, an access class of the UE, or an establishment cause of the connection.

### BRIEF DESCRIPTION OF THE DRAWINGS

FIG. 1 illustrates an example of a wireless communications system that supports control plane operation for disaggregated radio access network (RAN) in accordance with aspects of the present disclosure.

FIG. 2 illustrates an example of a network architecture in accordance with aspects of the present disclosure.

FIG. 3 illustrates an example of interfaces used for communications in a network in accordance with aspects of the present disclosure.

FIG. 4 illustrates an example of different modes for communicating with a central unit (CU) in accordance with aspects of the present disclosure.

FIG. 5 illustrates an example of a transparent mode for new radio (NR) wireless local area network (NR-WLAN) integration in accordance with aspects of the present disclosure.

FIG. 6 illustrates an example of an integrated mode for NR-WLAN integration in accordance with aspects of the present disclosure.

FIG. 7 illustrates an example of a wireless communications system that supports control plane operation for disaggregated RAN in accordance with aspects of the present disclosure.

FIG. 8 illustrates an example of pre-configuration-based WLAN node discovery and selection in accordance with aspects of the present disclosure.

FIG. 9 illustrates an example of system information signaling in accordance with aspects of the present disclosure.

FIG. 10 illustrates an example of paging delivery over WLAN in accordance with aspects of the present disclosure.

FIG. 11 illustrates an example of tables including information for quality of service (QoS) handling in WLAN in accordance with aspects of the present disclosure.

FIG. 12 illustrates an example of a process flow that supports control plane operation for disaggregated RAN in accordance with aspects of the present disclosure.

FIG. 13 illustrates an example of a process flow that supports control plane operation for disaggregated RAN in accordance with aspects of the present disclosure.

FIG. 14 illustrates an example of a process flow that supports control plane operation for disaggregated RAN in accordance with aspects of the present disclosure.

FIGS. 15 and 16 show block diagrams of devices that support control plane operation for disaggregated RAN in accordance with aspects of the present disclosure.

FIG. 17 shows a block diagram of a communications manager that supports control plane operation for disaggregated RAN in accordance with aspects of the present disclosure.

FIG. 18 shows a diagram of a system including a device that supports control plane operation for disaggregated RAN in accordance with aspects of the present disclosure.

FIGS. 19 and 20 show block diagrams of devices that support control plane operation for disaggregated RAN in accordance with aspects of the present disclosure.

FIG. 21 shows a block diagram of a communications manager that supports control plane operation for disaggregated RAN in accordance with aspects of the present disclosure.

FIG. 22 shows a diagram of a system including a device that supports control plane operation for disaggregated RAN in accordance with aspects of the present disclosure.

FIGS. 23 through 25 show flowcharts illustrating methods that support control plane operation for disaggregated RAN in accordance with aspects of the present disclosure.

### DETAILED DESCRIPTION

In some wireless communications systems, mobile devices may communicate with a network node using one or more types of wireless communications. Different types of wireless communications may be associated with different network configurations for supporting communications between a mobile device and other devices. The mobile device may be a user equipment (UE) or a station (STA), and the other devices may be devices on the same network or external networks (e.g., the Internet, a public switched telephone network (PSTN), other communications networks).

In some implementations, a first type of communications may refer to cellular communications in accordance with the 3rd Generation Partnership Project (3GPP) standards, and a second type of communications may refer to WiFi communications in accordance with the Institute of Electrical and Electronics Engineers (IEEE) 802.11 standards. Each type of wireless communications may support communications using one or more radio access technologies (RATs). For example, a first type of communications may be referred to as a wireless wide area network (WWAN) and may support RATs such as Long Term Evolution (LTE) or fifth-generation (5G) technologies. A WWAN may include networks run by one or more operators, where a public land mobile network (PLMN) may refer to communications services offered by a specific network operator. A second type of communications may be referred to as a wireless local area network (WLAN), and may support RATs based on the IEEE 802.11 family of standards or other WLAN technologies. In an example, a UE may communicate with a base station associated with a first type of communications (e.g., an LTE or 5G radio access network (RAN)), the UE may communicate with an access point associated with a second type of communications (e.g., WLAN), or the UE may communicate using both types of communications. Efficient techniques for facilitating communications over the WLAN with control plane termination in nodes of a WWAN network may be desirable.

In some wireless communications systems, a UE may support communications over a WLAN with control plane termination (e.g., at a central unit (CU)) in a 5G RAN. This architecture may be referred to as a disaggregated RAN. In such systems, it may be challenging to provide mechanisms to support discovery of WLAN access points that support control plane termination at a 5G RAN. In addition, it may be challenging to distribute system information and paging for a 5G RAN to a UE. For instance, system information and paging may be provided to a UE via an interface with the 5G RAN from a distributed unit (DU) since there may be no mechanism to provide the system information and paging over WLAN. Further, there may be no mechanism for determining an access category for traffic associated with a 5G bearer that is communicated via a WLAN access point.

As described herein, a wireless communications system may support efficient techniques for facilitating discovery of WLAN access points and communications over a WLAN with control plane termination in a 5G RAN. In one aspect, a user equipment (UE) may be provided with WLAN identifiers associated with a PLMN for determining WLAN access points that support control plane termination at a fifth generation (5G) RAN for the PLMN. In another aspect, a network node may encapsulate system information in a broadcast message for transmission from a WLAN access point to a UE, and the UE may be configured to receive the system information from the WLAN access point in one or more modification periods. In yet another aspect, a network node may encapsulate a paging message for a broadcast or unicast transmission from a WLAN access point to a UE. In yet another aspect, UEs and network nodes may be configured to map traffic characteristics of traffic for a 5G bearer to WLAN access categories.

Aspects of the disclosure are initially described in the context of wireless communications systems. Examples of processes and signaling exchanges that support control plane operation for disaggregated RAN are then described. Aspects of the disclosure are further illustrated by and described with reference to apparatus diagrams, system diagrams, and flowcharts that relate to control plane operation for disaggregated RAN.

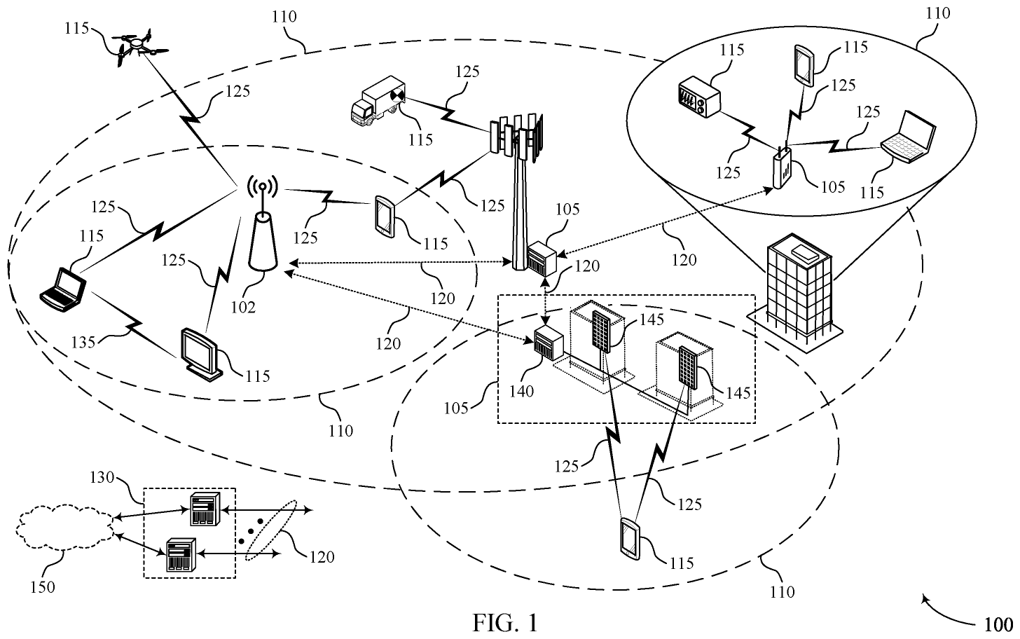

FIG. 1 illustrates an example of a wireless communications system 100 that supports control plane operation for disaggregated RAN in accordance with aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105 (e.g., in a physical uplink control channel (PUCCH) or a physical uplink shared channel (PUSCH)), or downlink transmissions from a base station 105 to a UE 115 (e.g., in a physical downlink control channel (PDCCH) or a physical downlink shared channel (PDSCH)). Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of TS=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC), central unit (CU), or distributed unit (DU). Each access network entity 140 may communicate with the UEs 115 through one or more other access network transmission entities 145, which may be referred to as radio units (RUs), radio heads, smart radio heads, remote radio heads (RRHs), or transmission/reception points (TRPs). Each access network transmission entity 145 may include one or more antenna panels. In some configurations, various functions of each access network entity 140 or base station 105 may be distributed across various network devices (e.g., ANC, CU, DU, RU) or consolidated into a single network device (e.g., a base station 105). Communication between a network entity 140 and other devices may refer to communication between the devices and any network entity 140 of the base station. For example, the terms “transmitting” or “receiving,” when referring to a network entity 140 (e.g., network node) of an access network, may refer to any network entity 140 of a RAN communicating with another device (e.g., directly or via one or more other network entities 140).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

According to some aspects, the wireless communication system 100 may include a WLAN such as a Wi-Fi network. The WLAN may be a network implementing at least one of the IEEE 802.11 family of wireless communication protocol standards (such as that defined by the IEEE 802.11-2016 specification or amendments thereof including, but not limited to, 802.1 lay, 802.11ax, 802.11az, 802.11ba and 802.11be). The WLAN may include numerous wireless communication devices such as an AP 102 and multiple stations (STAs) 115. While only one AP 102 is shown, the WLAN network also can include multiple APs 102.

Each of the STAs 115 may also be referred to as a UE 115, a LAN client, a mobile station (MS), a mobile device, a mobile handset, a wireless handset, an access terminal (AT), a user equipment (UE), a subscriber station (SS), or a subscriber unit, among other possibilities. The STAs 115may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the LTE, 3G, 4G or 5G (NR) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), SU-MIMO and MU-MIMO. The described implementations also can be implemented using other wireless communication protocols or RF signals suitable for use in one or more of a wireless personal area network (WPAN), a WLAN, a wireless wide area network (WWAN), or an internet of things (IOT) network.

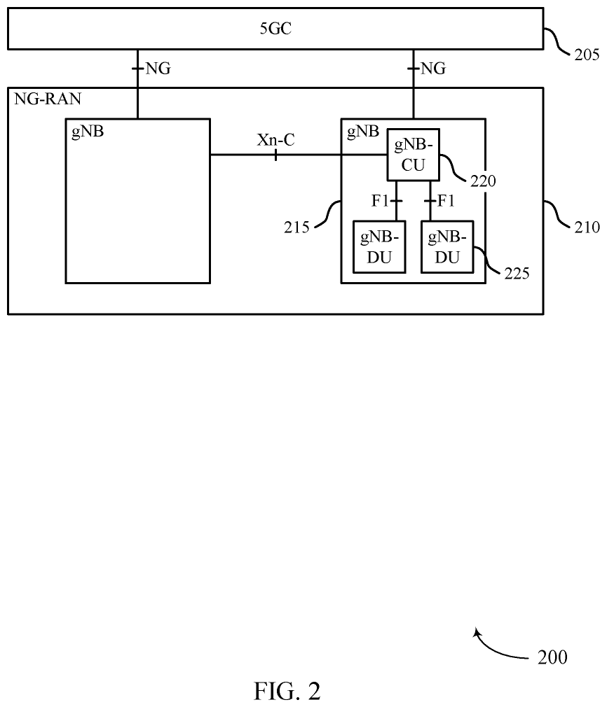

FIG. 2 illustrates an example of a network architecture 200 in accordance with aspects of the present disclosure. A next generation (NG) RAN 210 may include a set of base stations 105 connected to a 5G core network (5GC) 205 through an NG interface. A base station 105 may support an FDD mode, TDD mode, or dual mode operation. Base stations 105 may be interconnected through an Xn interface. A base station 105 may consist of a base station CU and one or more base station DUs, and a base station CU and a base station DU may be connected via an F1 interface. In some cases, one base station DU may be connected to only one base station CU. In an example, the NG-RAN 210 may consist of a set of NG base stations 105, where an NG base station 215 may consist of an NG base station CU 220 and one or more NG base station DUs 225. An NG base station CU 220 and an NG base station DU 225 may be connected via a W1 interface. The techniques described herein may also apply to an NG base station 215 and a W1 interface.

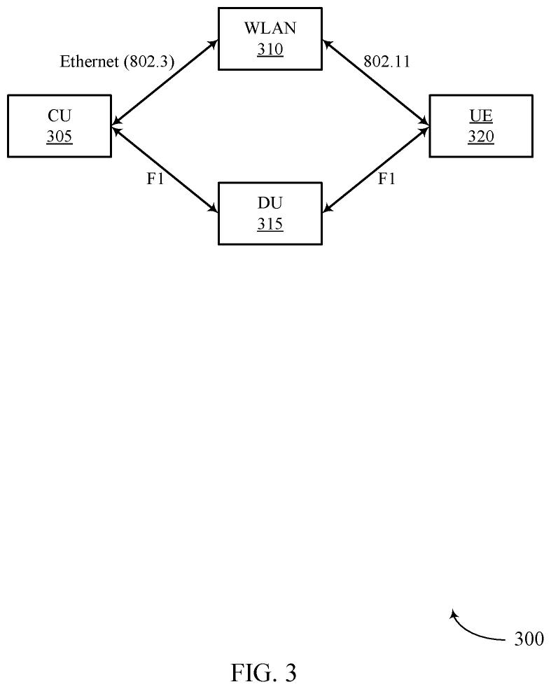

FIG. 3 illustrates an example of interfaces 300 used for communications in a network in accordance with aspects of the present disclosure. A CU 305 may communicate with a WLAN access point 310 over an Ethernet 802.3 interface, and the WLAN access point 310 may communicate with a UE 320 over an 802.11 interface. The CU 305 may communicate with a DU 315 over an F1 interface, and the DU 315 may communicate with the UE 320 over an F1 interface. In some cases, the UE 320 may communicate with the CU 305 over the WLAN access point 310 using a transparent mode or an integrated mode. In the transparent mode, the CU 305 may be connected to the WLAN access point 310 via IP routing, and, in the integrated mode, the WLAN access point 310 may be coupled to a termination node that provides a dedicated interface to the CU 305.

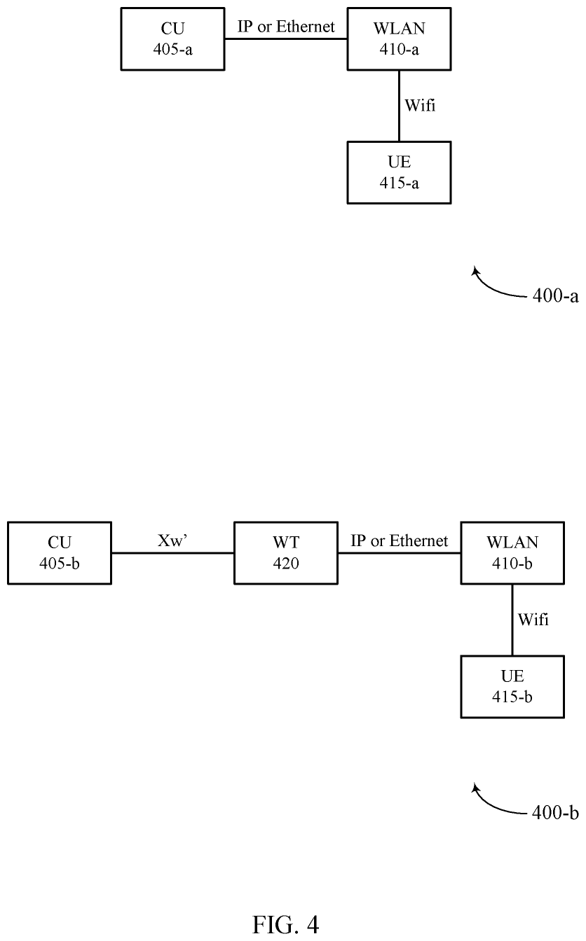

FIG. 4 illustrates an example of different nodes 400 for communicating with a CU in accordance with aspects of the present disclosure. In a first example 400-a, a UE 415-a may communicate with a WLAN access point 410-a using Wi-Fi, and the WLAN access point 410-a may communicate with a CU 405-a using IP or Ethernet routing. The first example 400-a may be an example of a transparent mode for communications between the CU 405-a and the WLAN access point 410-a. In a second example 400-b, a UE 415-b may communicate with a WLAN access point 410-b using Wi-Fi, and the WLAN access point 410-b may communicate with a WLAN terminated (WT) node 420 using IP or Ethernet routing. The WT node 420 may then communicate with a CU 405-b over a specified interface (e.g., Xw interface). The second example 400-b may be an example of an integrated mode for communications between the CU 405-b and the WLAN access point 410-b.

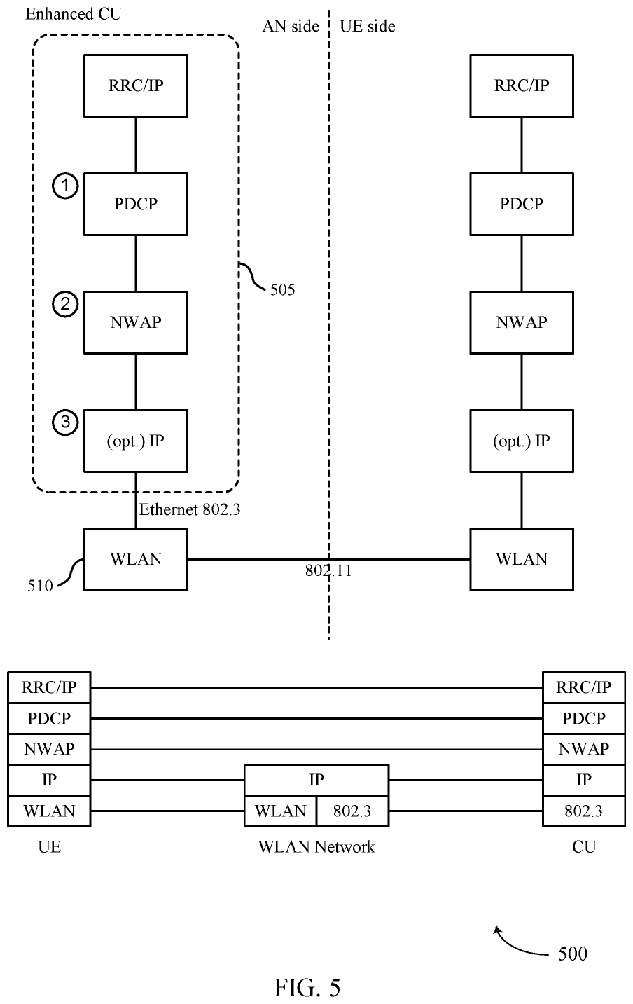

FIG. 5 illustrates an example of a transparent mode 500 for NR-WLAN integration in accordance with aspects of the present disclosure. In the transparent mode 500, a CU 505 may communicate directly with a WLAN access point 510 (e.g., over an Ethernet 802.3 interface). In some cases, the CU 505, a UE 115, or both may use a PDCP layer as an anchor and may reuse existing PDCP functionality. The CU 505 may include an RRC/IP layer, a PDCP layer, an NWAP layer, and, optionally, an IP layer. The PDCP layer may be configured with whether to send data to the NWAP layer, and a bearer ID may be added to messages at the NWAP layer. The IP layer may use IP routing over a WLAN. If there is no IP layer in the CU 505, the CU 505 may communicate with the WLAN access point 510 using an Ethernet layer-2 switch.

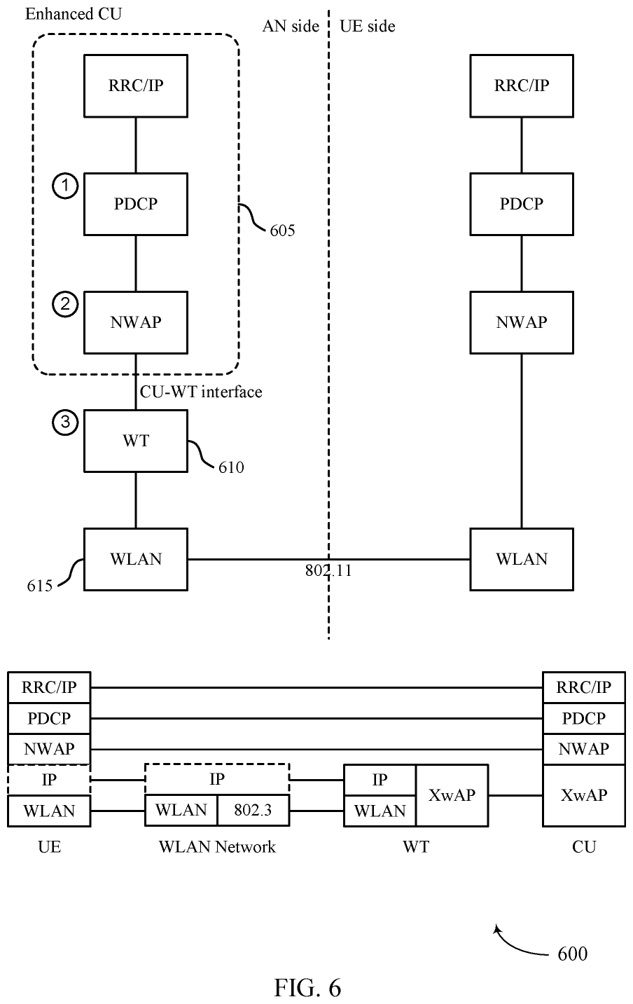

FIG. 6 illustrates an example of an integrated mode 600 for NR-WLAN integration in accordance with aspects of the present disclosure. In the integrated mode 600, a CU 605 may communicate with a WLAN access point 615 via a WT node 610. The CU 605 may communicate with the WT node 610 over a CU-WT interface. In some cases, the CU 605, a UE 115, or both may use a PDCP layer as an anchor and may reuse existing PDCP functionality. The CU 605 may include an RRC/IP layer, a PDCP layer, and an NWAP layer. The PDCP layer may be configured with whether to send data to the NWAP layer, and a bearer ID may be added to messages at the NWAP layer. Messages from the CU 605 to the WT node 610 may be over an Xw interface (e.g., as a baseline), with an enhancement for RRC container forwarding as defined in an F1 application protocol (F1AP) or using a general packet radio service tunneling protocol user (GTP-U). In some cases, the WT node 610 may be introduced to achieve similar functionality to communications over F1 and Xw interfaces and data forwarding over WLAN.

Thus, in accordance with FIGS. 2-6, a 5G RAN in wireless communications system 100 may include a CU connected to one or more WLAN access points 102 using a transparent mode or an integrated mode. This architecture may facilitate communications between a CU and an access point 102 and may be referred to as a disaggregated RAN.

Communications between the CU and the access point 102 may promote RRC connection reliability when a DU is deployed in a millimeter wave (mmW) frequency band. Further, such communications may allow a network to achieve control plane reliability (e.g., with minimal changes to WLAN or keeping WLAN unchanged). For instance, such communications may facilitate control plane message duplication through NR and WLAN, reliable control plane message dynamic switching between NR and WLAN, control plane message transmission reselection between NR and WLAN, and minimum user plane data loss. Given the improved efficiency of networks supporting communications between a CU and an access point 102, it may be appropriate to provide mechanisms to support such communications. In some cases, however, it may be challenging to facilitate communications over a WLAN with control plane termination in a 5G RAN.

In one aspect, it may be challenging to provide mechanisms to support discovery of WLAN access points that support control plane termination at a 5G RAN. In order for a UE 115 to access a CU over a WLAN, it may be appropriate for the UE 115 to discover a WLAN node connected to the CU. In addition, when the UE 115 discovers multiple WLAN nodes connected to CUs, it may be appropriate for the UE 115 to select one WLAN node and one CU. Further, it may be appropriate for the WLAN node selection to account for PLMN selection.

In another aspect, it may be challenging to distribute system information and paging for a 5G RAN to a UE. In order to allow a UE 115 out of DU cell coverage to access a CU, or in order to offload a system information or paging load in a DU link, it may be appropriate to deliver system information or paging messages to the UE over WLAN (e.g., which may not be possible if system information or paging messages are only delivered to the UE 115 over a Uu interface). In some cases, however, there may be no mechanism to deliver a system information or paging message over WLAN.

In yet another aspect, it may be challenging to determine an access category for traffic associated with a 5G bearer that is communicated via a WLAN access point. In some cases, it may be appropriate for a UE 115 to obtain a related user priority of a message and to perform enhanced distributed channel access (EDCA) based on a specified user plane to access category mapping. Further, if the UE 115 is expected to perform an admission control procedure and send an add traffic stream (ADDTS) message to an access point 102, it may be appropriate for the STA to include a user priority in the ADDTS message. In addition, if an IP packet is used to carry a 3GPP PDU, then it may be appropriate to use a differentiated services code point (DSCP) in an IP header to differentiate the QoS. Further, when a UE 115 accesses a CU, it may be appropriate for the UE 115 to obtain the user plane or DSCP information for traffic to be transmitted.

Wireless communications system 100 may support efficient techniques for facilitating communications with a network node (e.g., at a RAN) over a WLAN. In one example, wireless communications system 100 may support efficient techniques for facilitating discovery of WLAN access points to allow a UE 115 to select and establish a connection with an access point 102 connected to a CU. Wireless communications system 100 may also support efficient techniques for delivering system information or paging messages over WLAN. In some cases, the techniques described herein for communications over WLAN may also apply to other RATs (e.g., any non-3GPP RAT). In addition, UEs and network nodes in wireless communications system 100 may be configured to map traffic characteristics of traffic for a 5G bearer to WLAN access categories.

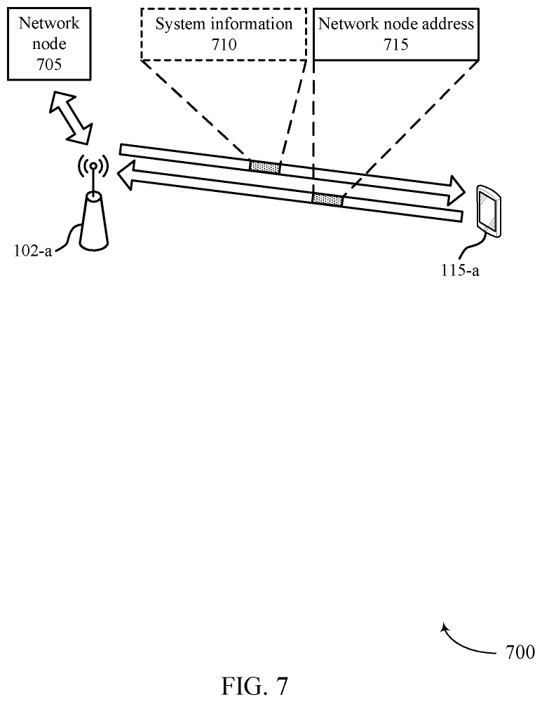

FIG. 7 illustrates an example of a wireless communications system 700 that supports control plane operation for disaggregated RAN in accordance with aspects of the present disclosure. The wireless communications system 700 includes a UE 115-a, which may be an example of a UE 115 described with reference to FIGS. 1-6. The wireless communications system 700 also includes an access point 102-a, which may be an example of an access point 102 described with reference to FIGS. 1-6. The wireless communications system 700 also includes a network node 705, which may be an example of a network node (e.g., a CU or WT node) described with reference to FIGS. 1-6. The wireless communications system 700 may implement aspects of the wireless communications system 100. For example, the wireless communications system may support efficient techniques for facilitating communications with the network node 705 (e.g., at a RAN) over a WLAN.

In one aspect, the UE 115-a may use a set of WLAN identifiers for each PLMN to identify access points 102 in each PLMN capable of communicating with the network node 705. The WLAN identifiers for a PLMN may be service set identifiers (SSIDs) of access points 102 in the PLMN capable of communicating with the network node 705. The UE 115-a may perform PLMN selection and may determine an SSID of an access point in the selected PLMN. For instance, the UE 115-a may determine the SSID of the access point 102-a capable of communicating with the network node 705 since the WLAN identifiers for the selected PLMN may include the SSID of the access point 102-a. The UE 115-a may also determine an address of the network node 705 (e.g., CU or WT address) based on the selected PLMN. The UE 115-a may then transmit an indication of the network node address 715 to the access point 102-a, and the UE 115-a may communicate with the network node 705 over the WLAN via the access point 102-a.

In some examples, the UE 115-a may be preconfigured with the set of WLAN identifiers for each PLMN. In other examples, the UE 115-a may receive system information 710 from the network node 705 over a WLAN indicating the set of WLAN identifiers. For example, the UE 115-a may receive system information 710 from the network node 705 over a WLAN and may obtain the PLMN in the system information 710. Additionally, or alternatively, a node in the WLAN (e.g., WLAN node or access point) may broadcast PLMN information, and the UE 115 may receive the PLMN information and perform PLMN selection. For instance, the PLMN information may include the set of WLAN identifiers for each PLMN. The UE 115 may then select the WLAN node (e.g., the access point 102-a) broadcasting an SSID associated with the selected PLMN.

In some cases, the network node 705 may generate the system information 710 applicable to be sent over a WLAN. The system information 710 may include content for the UE 115-a to access the network over the WLAN. The network node 705 may encapsulate the system information 710 in a broadcast packet, and the network node 705 may transmit the broadcast packet to the access point 102-a. In some cases, an adaptation layer at the network node 705 may indicate that the broadcast packet includes system information. The access point may then transmit the broadcast packet with the system information 710. The UE 115-a may receive the broadcast packet over the WLAN, and, if the adaptation layer is present at the UE for determining the system information 710 from the broadcast packet, the UE 115-a may determine whether the broadcast packet includes the system information 710. The wireless communications system 100 may also introduce a system information modification period, and the UE 115-a may be expected to receive system information once during one modification period.

In another aspect, the network node may support one or more paging delivery methods. In one example, the network node may envelop a paging message payload into a broadcast Ethernet or IP packet with a source address set to the network node 705 address. In another example, the network node 705 may add paging related information at an adaptation layer, and, after receiving a PDU with paging information, the UE 115-a may determine whether to forward the received PDU to an RRC layer based on the paging related information at the adaptation layer. In yet another example, the network node 705 may obtain a UE 115-a address from a core network or from the UE 115-a, and the network node 705 may envelop a paging message into a unicast Ethernet or IP packet with the UE 115-a address as a destination address. In some cases, the network node 705 may determine to deliver paging over a WLAN based on a policy or parameters from the core network.

After receiving a paging message, the UE 115-a may respond to the paging message on an access network type on which the paging message is received (e.g., 5G or WLAN). In some cases, the UE 115-a may respond to the paging message on a higher priority access network type (e.g., preconfigured or indicated in paging). For instance, the UE 115-a may transmit a paging response over WLAN if WLAN has a higher priority than 5G, or the UE 115-a may transmit the paging response over 5G if 5G has a higher priority than WLAN. Alternatively, the UE 115-a may respond to the paging message on an access network type associated with better coverage (e.g., a stronger signal, more visible access points, or lower path loss). For instance, if the UE 115-a determines that WLAN has better coverage than 5G, the UE 115-a may transmit the paging response over WLAN. Alternatively, if the UE 115-a determines that 5G has better coverage than WLAN, the UE 115-a may transmit the paging response over 5G.

In yet another aspect, the UE 115-a and the network node 705 may be configured to map traffic characteristics of traffic for a 5G bearer to WLAN access categories. For uplink traffic, a UE 115 may perform traffic characteristic mapping to a user priority, DSCP, or access category. The traffic characteristic may be bearer information, a logical channel, QoS profiles, an access category, or an establishment cause. In some cases, the mapping rule may be configured at the UE 115 using RRC signaling or NAS signaling, or the mapping rule may be preconfigured at the UE 115 by subscription or otherwise defined at the UE 115. For downlink traffic with NR-WLAN integration in a transparent mode, the network node 705 (e.g., a RAN node) may perform mapping from a traffic characteristic to a user plane, DSCP, or access category. The RAN node may obtain the mapping rule from a core network. For downlink traffic with NR-WLAN integration in an integrated mode, the network node 705 (e.g., a WT node) may perform mapping from a traffic characteristic to a user plane, DSCP, or access category. A WT node may obtain the mapping rule from a RAN node.

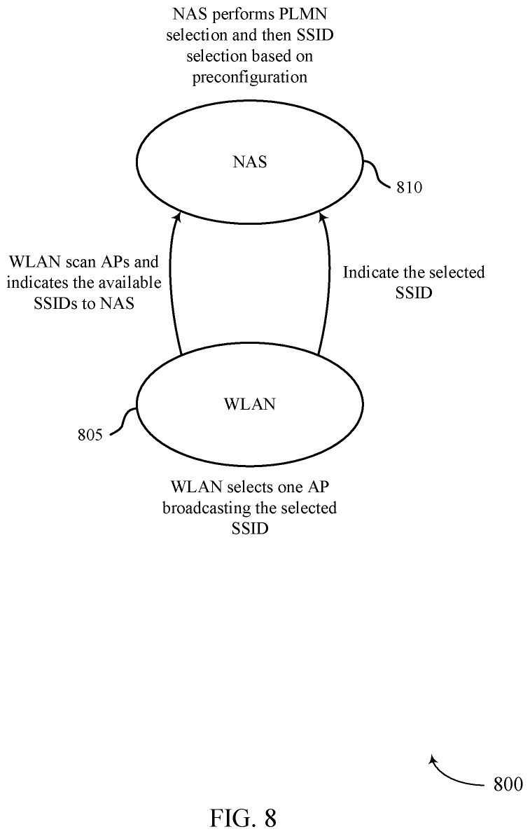

FIG. 8 illustrates an example of pre-configuration-based WLAN node discovery and selection 800 in accordance with aspects of the present disclosure. A UE 115 may be preconfigured with information associating each PLMN with access points. The PLMN information may include a set of WLAN identifiers, where a WLAN identifier may be an SSID. For instance, the PLMN information may be referred to as tuple information, and tuple information preconfigured at the UE 115 may include a PLMN ID, a set of SSIDs, a WT address per location area, or a CU address per location area. A UE WLAN component 805 may scan all access points 102 on supported or authorized frequency bands, and the WLAN component 805 may forward the available SSIDs (e.g., the SSIDs of the available access points 102) to a NAS layer 810 at the UE 115. In some cases, the WLAN component 805 may forward the available SSIDs directly to the NAS layer 810, and, in other cases, the WLAN component 805 may forward the available SSIDs to an RRC layer which may forward the available SSIDs to the NAS layer 810. The UE NAS layer 810 may determine available PLMNs according to the forwarded SSIDs and the mapping of SSIDs and PLMNs.

The UE NAS layer 810 may then perform PLMN selection (e.g., using existing mechanisms), and the UE NAS layer 810 may determine an SSID (e.g., of an access point with which to communicate) based on the selected PLMN. The UE NAS layer 810 may then indicate the selected SSID to the WLAN component 805. In some cases, the UE NAS layer 810 may indicate the selected SSID directly to the WLAN component 805, and, in other cases, the UE NAS layer 810 may indicate the selected SSID to an RRC layer which may indicate the selected SSID to the WLAN component 805. The UE NAS layer 810 may also determine a WT or CU address based on the selected PLMN or SSID. Further, the UE NAS layer 810 may take location information or a location area of the UE 115 into account when determining the WT or CU address (e.g., where the location area may be a timing advance list or a geographic location). The WLAN component 805 may select and associate an access point 102 broadcasting the selected SSID, and the UE 115 may signal the WT or CU address to the access point 102 so the access point 102 is able to (e.g., knows how to) communicate with the CU.

The pre-configuration information at the UE 115 may be updated by the network using a NAS procedure. For example, the pre-configuration information may be updated using a UE-parameters update procedure via a unified data management (UDM) control plane procedure. As part of the UDM control plane procedure, a UDM may decide to perform a UE-parameters update, and the UDM may transmit a subscriber data management (SDM) notification to an access and mobility management function (AMF), and receive SDM information from the AMF. The AMF may then transmit a downlink NAS transport message containing a PDU container to the UE 115, and the UE 115 may transmit an uplink NAS transport message containing a PDU acknowledgment. The AMF may then send additional SDM information to the UDM, and the UE 115 may initiate reregistration if requested by the UDM.

In some cases, the pre-configuration information may be updated by the network using RRC signaling (e.g., a system information message). For instance, the UE 115 may receive system information over 3GPP access, and the system information may include the PLMN information, one or more SSIDs, a CU address, or a WT address. The UE 115 may then store the tuple information (e.g., information associating each PLMN with access points) or replace the preconfigured tuple information. The UE 115 may receive system information over WLAN access, and the system information may include the PLMN information, one or more SSIDs, a CU address, or a WT address. The UE 115 may obtain the SSIDs broadcast by an access point, and the UE 115 may store the new (e.g., updated) tuple information or replace the preconfigured tuple information.

In addition to, or as an alternative to, the information associating PLMNs to access points being preconfigured at a UE 115, the UE 115 may support system information-based WLAN node discovery and selection. The UE 115 may scan all access points on supported or authorized frequency bands, and the UE 115 may receive a system information message (e.g., including PLMN information, CU address, WT address, etc.) from a CU sent over the access points 102. Alternatively, the UE 115 may receive the system information message from a DU sent over one or more base stations 105. The UE RRC layer may forward the available PLMN information to a NAS layer, and the UE NAS layer may perform PLMN selection (e.g., using existing mechanisms). The UE NAS layer may then indicate the selected PLMN to an RRC layer, and the RRC layer may select a WLAN node (e.g., access point) over which the system information including (e.g., indicating) the selected PLMN is received. The UE 115-a may obtain a CU address or WT address included in the system information sent over selected access points.

In some aspects, the UE 115 may support acquiring the information associating PLMNs with access points from WLAN nodes advertising information about the PLMNs. The WLAN nodes may advertise the information about the PLMNs that the WLAN nodes interwork with (e.g., by using an access network query protocol (ANQP), defined in an HS2.0 specification). A UE WLAN component may receive the PLMN information and forward the PLMN information to a NAS layer at the UE 115. The NAS layer may perform PLMN selection (e.g., using existing mechanisms), and the NAS layer may further determine a CU or WT address based on the selected PLMN information. The NAS layer may indicate the selected PLMN, the CU or WT address, or both to the WLAN component, and the WLAN component may select the WLAN node broadcasting the selected PLMN.

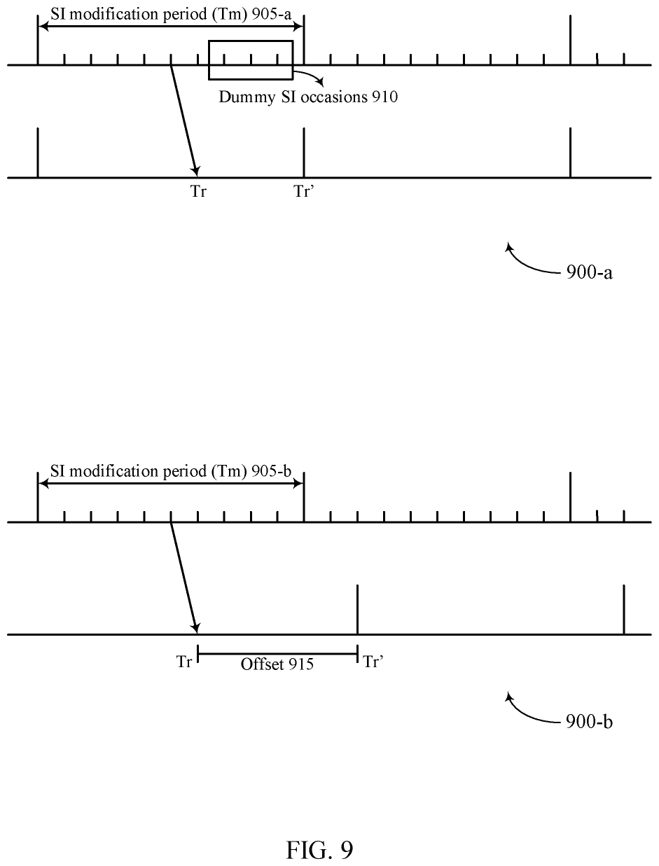

FIG. 9 illustrates an example of system information signaling 900 in accordance with aspects of the present disclosure. As mentioned, in some cases a CU may generate system information applicable to be sent over WLAN, and the system information may include content for a UE 115 to access a network over WLAN. The system information may include a CU address or WT address, a network barred indication, a PLMN list, and an indication of whether a network is reserved per PLMN. The CU may send the system information over WLAN as a broadcast packet, and the UE 115 may receive the system information in the broadcast packet. In some cases, the CU or WT may encapsulate system information in an adaptation PDU, and a system information indication or logical channel may be included in or at the adaptation layer.

Once the UE 115 powers on to find a CU, the UE 115 may receive a broadcast packet including system information over WLAN. If an adaptation layer is present at the UE 115, then the UE 115 may determine whether the broadcast packet is for or includes system information. If the broadcast packet is for or includes system information, the adaptation layer may forward the PDU to an RRC layer at the UE 115. The UE 115 may be expected to receive system information during modification periods or at modification times. For instance, during a modification period, the UE 115 may be expected to receive system information once. That is, if the system information modification period is introduced, during one system information modification period, the UE 115 may be expected to receive system information once.

The UE 115 may determine a system information modification period during which to receive system information using one or more techniques. As an example, the UE 115 may receive a reference starting time and a modification period value (e.g., a duration of a modification period) in a system information message. The reference time included in the system information may be an absolute time or a relative time. The network may then indicate to the UE 115 a next system information modification period or time. Once the UE 115 reads new system information (e.g., updated or most recent system information), the old system information (e.g., previously received system information) may be invalid (e.g., immediately), or upon expiration of a current modification period.

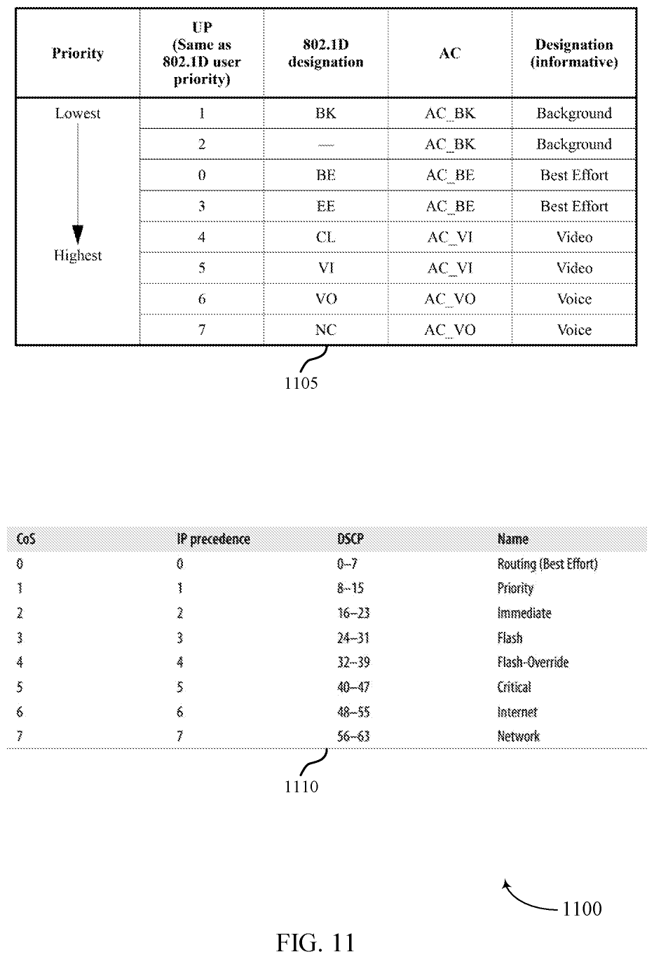

Examples of different techniques for establishing a modification period during which to receive system information are illustrated in FIG. 11.

In a first example 900-a, a UE 115 may receive system information indicating an absolute starting time for a modification period 905-a and a duration of the modification period 905-a. For instance, the network may include absolute starting time tabs and a duration of the system information modification period 905-a (Tm) in system information. The time Tr may indicate the time at which the UE 115 receives system information, and the UE 115 may be expected to receive new or updated system information at time Tr′. In order to prevent the UE 115 from reading old system information (e.g., system information in a previous system information modification period) in a new system information modification period, the network may skip several system information occasions at the end of a modification period. The skipped system information occasions may be referred to as dummy system information occasions 910.

In a second example 900-b, a UE 115 may receive system information indicating a relative starting point for a modification period 905-b and a duration of the modification period 905-b. For instance, the network may include the offset 915 and the system information modification period 905-b (Tm) in system information. The offset 915 may be a gap between the modification period starting time and the time of receiving the system information. The time Tr may be a time at which the UE 115 receives the system information, and the UE 115 may be expected to receive new or updated system information at time Tr′ (e.g., after the offset 915).

In yet another example, a UE 115 may receive system information indicating a next modification absolute time (e.g., an absolute indication of a time at which the UE 115 is to receive system information). For instance, the network may indicate, in system information, the next modification absolute time, and the UE 115 may be expected to read system information at that time. In yet another example, a UE 115 may receive system information indicating a time offset to a next modification time (e.g., a relative indication of a time at which the UE 115 is to receive system information). For instance, the network may indicate, in system information, an offset between the next modification time and a time of receiving the system information (e.g., at the UE 115). The UE 115 may then read the system information at the time given by the current system information reception time plus the offset. Thus, the modification time may refer to a time at which the UE 115 is expected to receive system information. In some cases, in addition to, or as an alternative to, receiving an indication of a modification time or modification period in system information, a modification period or modification time for receiving system information may be defined (e.g., preconfigured) at the UE 115 and the network (e.g., defined in a specification).

In some cases, the UE 115 may receive system information over both a DU and a WLAN. In such cases, if the UE 115 receives system information over DU and WLAN links, it may be appropriate for the UE 115 to utilize the system information received over the DU, the system information received over WLAN, or both. In one example, the UE 115 may select the system information to use based on a preconfigured rule (e.g., a rule indicating that system information over a DU is valid). The preconfigured rule may be included in subscription data or configured by a core network. In another example, a CU may indicate in system information a link or RAT that has priority (e.g., which link or RAT has priority). The UE 115 may then treat the system information over a higher priority link or RAT as valid. In some examples, the UE 115 may take system information over a DU link or 5G RAT as higher priority. The system information over the DU link or 5G RAT may overwrite the system information over a WLAN link or WLAN RAT. In some cases, some parameters included in system information received over a higher priority link or RAT may replace the same parameters included in system information received over a lower priority link or RAT.

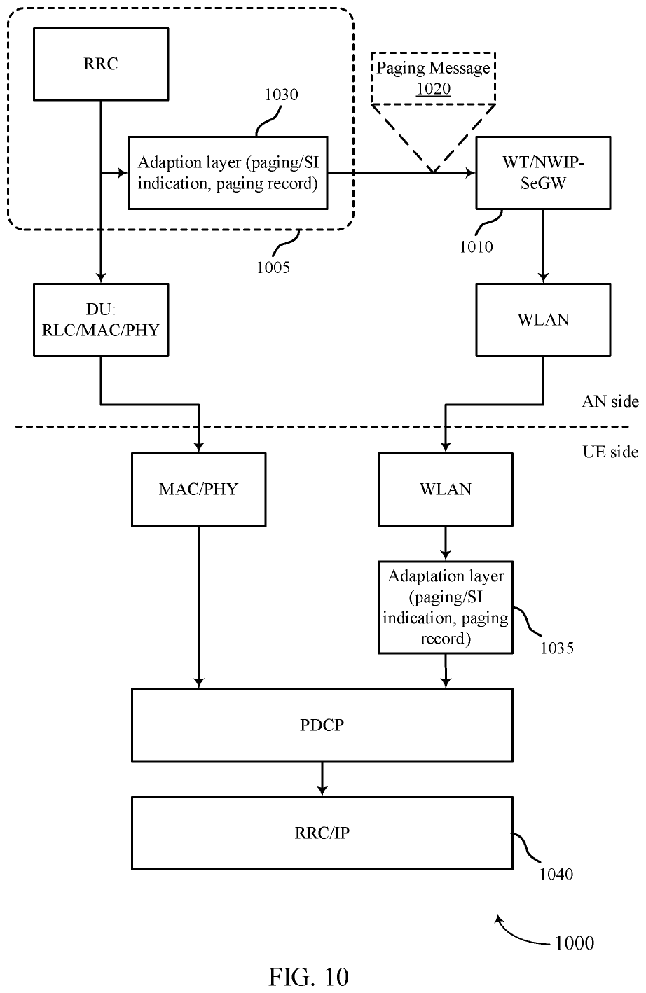

FIG. 10 illustrates an example of paging delivery 1000 over WLAN in accordance with aspects of the present disclosure. In a transparent mode, when paging happens, a CU 1005 may generate a paging message 1020 and may determine that the paging message 1020 is to be delivered over WLAN. In some aspects, the CU may send a paging RRC message to a WLAN network. For instance, the CU may envelop the paging message payload into an Ethernet or IP packet with a source address set to the CU address and a destination address set to a wildcard value (e.g., indicating that the enveloped paging message is to be broadcast). The WLAN network may then transmit the paging message using broadcast. When a UE 115 receives the paging message (e.g., packet), a WLAN component at the UE 115 may forward the paging message to an RRC layer, and the RRC layer may decode the message. If a paging record in the paging message is set to the ID of the UE 115, the UE 115 may respond to the paging message. Otherwise, the UE 115 may discard the paging message.

In some cases, the CU may add paging related information to the paging message 1020 in or at an adaptation layer 1030. The paging related information may be information indicating that the paging message 1020 is a paging message (e.g., a paging indication, logical channel (paging control channel (PCCH)) information, or a paging record). When the UE 115 receives the paging message, the adaptation layer 1035 at the UE 115 may identify that the paging message is a paging message, and the adaptation layer 1035 may forward the paging message to an RRC layer 1040. If a paging record is included in the paging message, the UE 115 may check in an adaptation layer 1035 whether the paging message is for the UE 115. If the paging message is for the UE 115, the adaptation layer 1035 may forward the paging message to an RRC layer 1040. Otherwise, the adaptation layer 1035 may discard the paging message.

In some implementations, the CU may set the destination address of a paging message 1020 to an address of the UE 115 (e.g., UE address). The CU may obtain the UE address (e.g., IP address or MAC address) in one or more ways. For instance, a core network may inform the CU of the UE address when sending a paging request. Additionally, or alternatively, for an inactive state (e.g., if the UE 115 supports an inactive state), the CU may obtain the UE address during a connected mode, and the CU may store the UE address in UE context, or a core network may include the UE address in a UE context setup request sent to the UE 115. In some cases, the UE 115 may indicate the UE address to the core network during a registration procedure, and the core network may store the UE address in the UE context.

In an integrated mode, when paging happens, a CU 1005 may generate a paging message and may determine that the paging message is to be delivered over WLAN. In the integrated mode, after the CU 1005 generates an RRC PDU containing the paging message 1020 or an adaptation PDU containing the paging message, the CU may send the PDU to a WT node 1010 using a protocol defined between the CU 1005 and the WT node 1010 (e.g., a security gateway (SeGW)). If the CU 1005 has the UE address information (e.g., identifies the UE address), the CU 1005 may send the UE address to the WT node 1010. The WT node 1010 may then set the destination address of the paging message to the UE address. Otherwise, the WT node 1010 may use a broadcast address to transmit the paging message.

In some cases, the CU may determine to deliver paging or transmit paging messages over WLAN based on one or more factors. In one example, the CU may receive a paging policy from a core network indicating a RAT over which to send a paging message (e.g., which side the paging can be sent, such as a 5G side or a WLAN side). In another example, the CU may firstly page the UE 115 over a 3GPP link (e.g., RAT) or 5G link (e.g., RAT), and, if the paging fails, the CU may page the UE 115 over WLAN (e.g., for an inactive state). In yet another example, the CU may page the UE 115 over WLAN (e.g., always). In yet another aspect, the CU may page the UE 115 over both a WLAN link AND a 3GPP link. In yet another aspect, the CU may select to deliver paging over WLAN based on information in a paging request from a core network. For instance, the CU may page the UE 115 over WLAN, 3GPP, or both based on whether a DRX cycle of the UE 115 is larger than a threshold. Further, the CU may page the UE 115 over WLAN, 3GPP, or both based on slicing information in the paging request (e.g., based on whether the UE is a massive MTC device). In yet another aspect, for an inactive state, the CU may select to deliver paging over WLAN based on a PDU session or QoS flow information of arriving downlink data. In yet another aspect, if the UE address is received from the core network in a paging request or a UE context setup request, then the CU may send paging over a WLAN.

Once the UE 115 receives the paging over WLAN or over a DU link, it may be appropriate for the UE 115 to respond to the paging. In one aspect, the UE 115 may respond to the paging over WLAN or the DU link respectively (e.g., the same link or RAT over which the paging was received). For instance, the UE 115 may establish or resume RRC connection over the WLAN or DU respectively. In another aspect, the network may set an access network type priority for UEs 115 when responding to paging. When the UE 115 receives paging with an indication of an access network type priority, the UE 115 may respond to the paging over an access network (e.g., WLAN or 3GPP) associated with a higher or highest priority access network type. If the UE 115 has no or limited coverage under the indicated higher or highest priority RAT, the UE 115 may respond to the paging over an access network associated with a lower priority access network type. In yet another aspect, the UE 115 may select an access network or access network type over which to respond to the paging based on which access network or access network type has better coverage. That is, the UE 115 may select the better coverage of access network type to respond to the paging.

FIG. 11 illustrates an example of tables 1100 including information for QoS handling in WLAN in accordance with aspects of the present disclosure. As shown in the first table 1105, in WLAN, there may be four access categories defined for QoS handling. Table 1110 shows a mapping between each differentiated services code point (DFCP) used for packet classification and a class of service (CoS), which may be comparable or equivalent to a user priority. In some cases, there may be a mapping between the QoS parameter user priority and an access category. This mapping may be used, for example, when an access point 102 performs a QoS handling procedure (e.g., admission control, such as for enhanced distributed channel access). For admission control, an access point 102 may obtain user priority information from a UE 115 (e.g., a STA) and may determine whether to admit access from the UE 115. For EDCA, the UE 115 may perform EDCA for each access category based on advertised EDCA parameters from an access point. The UE 115 may map from a user priority to an access category. If IP is used for communications between a UE 115 and an access point 102, the UE 115 or the access point 102 may perform a mapping from a DSCP to a user priority or access category.

When communicating with an access point 102, it may be appropriate for a UE 115 to identify user priority or DSCP information for traffic to be transmitted to the access point 102. As such, using the techniques described herein, the UE 115 may perform a mapping from a 3GPP traffic characteristic to an access category, user priority, or DSCP (e.g., for uplink data or an uplink transmission).

In some aspects, the 3GPP traffic characteristic may be bearer or logical channel information. When traffic data comes to a UE 115, the UE 115 may determine bearer or logical channel information for the traffic data (e.g., using an existing procedure). The UE 115 may then map from the bearer or logical channel information to an access category, user priority, or DSCP based on a configured mapping rule. The mapping handling may be performed in an adaptation layer (e.g., NWAP) or an RRC layer at the UE 115. If the mapping is performed at an RRC layer, the RRC layer may forward the mapped access category, user priority, or DSCP to an adaptation layer or a UE entity. The bearer associated with the bearer information may be a signaling radio bearer (SRB) or a dedicated radio bearer (DRB). In some cases, the mapping or mapping rule may be configured by a RAN node to the UE 115 using RRC signaling. In such cases, the RAN node may obtain the mapping rule from a core network. In some examples, the mapping may be specific to a PDU session, slice, or a PLMN.

In other aspects, the 3GPP traffic characteristic may be a QoS profile (e.g., a 5G QoS identifier (5QI) or a QoS flow identifier (QFI)). When traffic data comes to a UE 115, the UE 115 may determine the 5QI or QFI (e.g., using an existing procedure), and the UE 115 may map from the 5QI or the QFI to an access category, user priority, or DSCP. The UE 115 may then forward the mapped user priority or DSCP to a UE entity or to an RRC layer which then forwards the mapped user priority to the UE entity. The mapping rule may be configured by a core network to the UE 115 using NAS signaling, or the mapping rule may be preconfigured in subscription information at the UE 115 or defined in a specification, In some cases, the mapping (e.g., mapping rule or configuration) may be specific to a PDU session, slice, PLMN, or registration area.

In yet other aspects, the 3GPP traffic characteristic may be an access category. When a traffic service comes to a UE 115, the UE 115 may determine the access category (e.g., using an existing procedure), and the UE 115 may map from the access category for 3GPP data to the access category, user priority, or DSCP for WLAN. The UE 115 may then forward the mapped access category, user priority, or DSCP to a UE entity. In some cases, a NAS layer at the UE 115 may perform the mapping and may forward the mapped user priority or DSCP to the UE entity or to an RRC layer which then forwards the mapped user priority or DSCP to the UE entity. In some cases, the RRC layer may perform the mapping and forward the mapped access category, user priority, or DSCP to the UE entity.

In yet other aspects, the 3GPP traffic characteristic may be an establishment cause. When a UE 115 is to establish an RRC connection over WLAN, an RRC layer may perform the mapping from an establishment cause to an access category, user priority, DSCP, and the RRC layer may forward the mapped access category, user priority, DSCP to a UE entity. The mapping rule may be configured by the core network to the UE 115 using NAS signaling, or the mapping rule may be preconfigured in subscription information at the UE 115 or defined in a specification. In some cases, the mapping (e.g., mapping rule or configuration) may be specific to a PDU session, slice, PLMN, or registration area.

For downlink data or downlink transmissions from an access point 102 to a UE 115, a network node may perform a mapping from a traffic characteristic to an access category, user priority, or DSCP depending on an NR-WLAN integration mode. For a transparent node, a RAN node (e.g., a CU) may perform the mapping from the traffic characteristic to an access category, user priority, or DSCP. The traffic characteristic may be bearer information, a 5QI, a QFI, or an establishment cause in a message 3 (e.g., MSG 3). The RAN node may obtain the mapping rule from a core network (e.g., an AMF or SMF using a next generation application protocol (NGAP) procedure). For an integrated mode, a WT node may perform the mapping from the traffic characteristic to the access category, user priority, or the DSCP. The traffic characteristic may be bearer information, a 5QI, a QFI, or an establishment cause in a MSG 3. The WT node may obtain the mapping rule from a RAN node (e.g., a CU using an XwAP procedure).

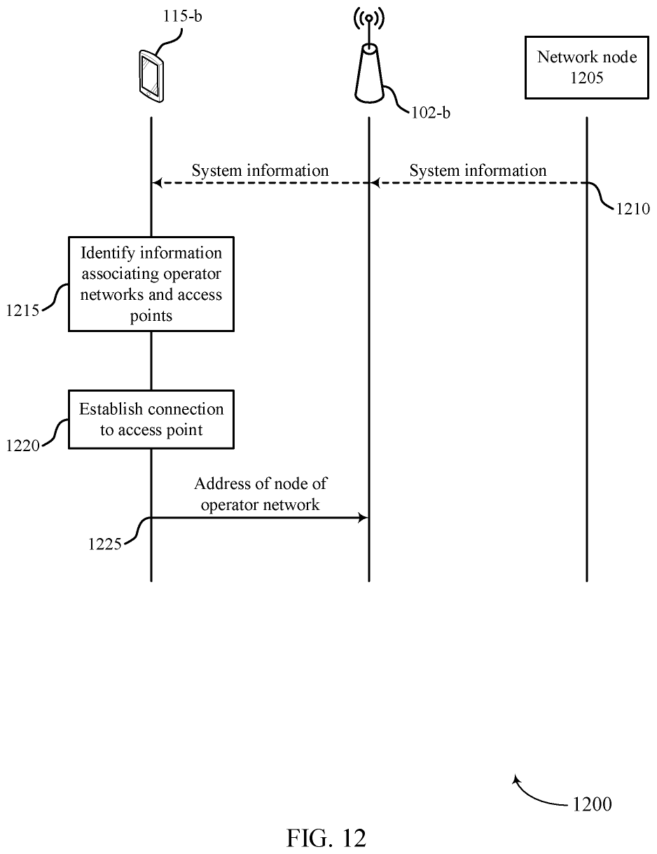

FIG. 12 illustrates an example of a process flow 1200 that supports control plane operation for disaggregated RAN in accordance with aspects of the present disclosure. The process flow 1200 includes a UE 115-b, which may be an example of a UE 115 described with reference to FIGS. 1-11. The process flow 1200 also includes an access point 102-b, which may be an example of an access point 102 described with reference to FIGS. 1-11. The process flow 1200 also includes a network node 1205, which may be an example of a network node (e.g., a CU or a WT node) described with reference to FIGS. 1-11. The UE 115-b may support communications via one or more RATs, including LTE, 5G, or WLAN. The UE 115-b may support LTE or 5G communications with a base station 105, and the UE 115-b may support WLAN communications with the access point 102-b.

The process flow 1200 may implement aspects of the wireless communications system 100 or the wireless communications system 900. For example, the process flow 1200 may support efficient techniques for facilitating discovery of WLAN access points and communications over a WLAN with control plane termination in an 5G RAN. In the following description of the process flow 1200, the signaling exchanged between the UE 115-b, the access point 102-b, and the network node 1205 may be exchanged in a different order than the example order shown, or the operations performed by the UE 115-b, the access point 102-b, or the network node 1205 may be performed in different orders or at different times. Some operations may also be omitted from the process flow 1200, and other operations may be added to the process flow 1200.

At 1210, the UE 115-b may receive system information from the access point 102-b associated with a base station 105 of a first RAT (e.g., 5G). The network node 1205 may encapsulate the system information in a broadcast message for transmission from the access point 102-b. For instance, the access point 102-b may use existing mechanisms to broadcast the message including the system information (e.g., without identifying that the broadcast message includes system information). The system information may include information associating operator networks with access points. The information may be respective sets of identifiers associated with a second RAT for each of multiple operator networks, where an identifier is linked to an access point. In some cases, the access point 102-b may advertise information about the operator networks (e.g., such as the information associating the operator networks with access points).

In some cases, the system information may include an indicator of a duration for a system information modification period or a starting time for the system information modification period, and the UE 115-b may monitor for updated system information from the access point 102-b based on the indicator. In some cases, the system information may include an indicator of a modification time for the system information, and the UE 115-b may monitor for updated system information from the access point 102-b based on the indicator. In some cases, the UE 115-b may receive second system information from the base station 105, and the UE 115-b may establish a wireless connection with the base station based on the system information or the second system information. For instance, the UE 115-b may select one of the system information or the second system information for the wireless connection based on a link priority for receiving system information, or the UE 115-b may overwrite a portion of the system information based on the second system information.

Additionally, or alternatively, the UE 115-b may be configured with information associating operator networks with access points. The information may be respective sets of identifiers associated with a second RAT for each of multiple operator networks, where an identifier is linked to an access point. In some cases, the UE 115-b may receive a configuration message from the network node 1205 including at least one updated set of identifiers for the respective sets of identifiers. For instance, the information associating operator networks with access points may be updated by the network node 1205. In some cases, the UE 115-b may receive the configuration message from a base station 105 associated with the first RAT or the access point 102-b. In some cases, the UE 115-b may receive, from the access point 102-b, an indicator of one or more operator networks supported by the access point 102-b for control plane communications associated with the first RAT.

At 1215, the UE 115-b may identify the information associating the operator networks with access points, and, at 1220, the UE 115-b may establish a first wireless connection to the access point 102-b associated with the second RAT based on the information associating the operator networks with access points. For instance, the UE 115-b may select the access point 102-b from a set of access points associated with the second RAT based on an operator network associated with the first RAT and the information associating the operator network and the access point. The UE 115-b may select the operator network associated with the first RAT, and then select the access point 102-b based on the operator network being associated with the access point 102-b. At 1225, the UE 115-b may then transmit, to the access point 102-b, an address associated with the network node 1205 for control plane termination for the UE 115-b for the first RAT. The access point 102-b may use the address to communicate with the network node 1205.

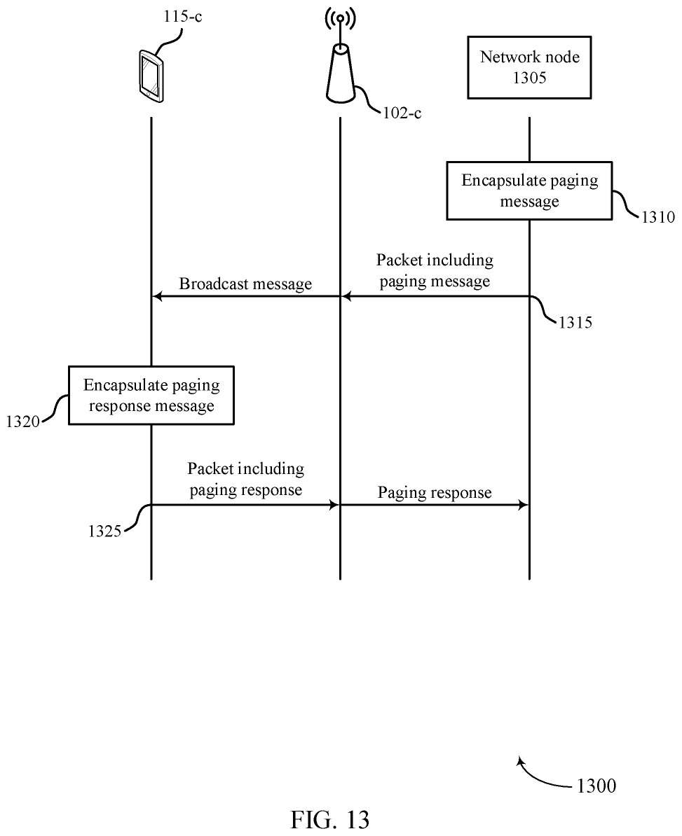

FIG. 13 illustrates an example of a process flow 1300 that supports control plane operation for disaggregated RAN in accordance with aspects of the present disclosure. The process flow 1300 includes a UE 115-c, which may be an example of a UE 115 described with reference to FIGS. 1-12. The process flow 1300 also includes an access point 102-c, which may be an example of an access point 102 described with reference to FIGS. 1-12. The process flow 1300 also includes a network node 1305, which may be an example of a network node (e.g., a CU or a WT node) described with reference to FIGS. 1-12. The UE 115-b may support communications via one or more RATs, including LTE, 5G, or WLAN. The UE 115-b may support LTE or 5G communications with a base station 105, and the UE 115-b may support WLAN communications with the access point 102-b.

The process flow 1300 may implement aspects of the wireless communications system 100 or the wireless communications system 900. For example, the process flow 1300 may support efficient techniques for facilitating discovery of WLAN access points and communications over a WLAN with control plane termination in an 5G RAN. In the following description of the process flow 1300, the signaling exchanged between the UE 115-c, the access point 102-c, and the network node 1305 may be exchanged in a different order than the example order shown, or the operations performed by the UE 115-c, the access point 102-c, or the network node 1305 may be performed in different orders or at different times. Some operations may also be omitted from the process flow 1300, and other operations may be added to the process flow 1300.

At 1310, the network node 1305 may encapsulate a paging message for the UE 115-c configured for communications via the first RAT and the second RAT. In some cases, the network node 1305 may set a destination address of the packet to an indicator that indicates to the access point 102-c to broadcast the packet. In some cases, the network node 1305 may set a source address of the packet to an address of the network node 1305. In some cases, the network node 1305 may send an address of the UE 115-c to the access point 102-c with the packet. In some cases, the network node 1305 may set a destination address of the packet to an address of the UE 115-c. In some cases, the network node 1305 may obtain the address of the UE 115-c from a core node of the first RAT or from a stored context associated with the UE.

At 1315, the network node 1305 may send a packet including the encapsulated paging message to the access point 102-c associated with the second RAT. The network node 1305 may determine to send the encapsulated paging message to the access point 102-c based on a predetermined paging policy, a paging policy received from a core node of the first RAT, a failure to receive a paging response from the UE 115-c after transmitting a prior paging message to the UE 115-c over a cell associated with the first RAT, a category of the UE 115-c, comparing a DRX cycle value associated with the UE 115-c and a threshold, a connection state of the UE 115-c, a characteristic of a PDU including data associated with a paging request received from the core node, a QoS of the data associated with the paging request, or receiving an address of the UE 115-c in the paging request.

The UE 115-c may receive the broadcast message from the access point 102-c including the paging message associated with the first RAT, and, at 1320, the UE 115-c may encapsulate a paging response message for transmission to the access point 102-c. At 1325, the UE 115-c may then respond to the paging message based on decoding the paging message. For instance, the UE 115-c may transmit a packet including an encapsulated paging response message to the access point 102-c. Alternatively, the UE 115-c may transmit a paging response message to a base station 105 associated with the operator network (e.g., the operator network selected for communications). In some cases, the UE 115-c may determine whether to transmit the packet including the encapsulated paging response message to the access point 102-b or to transmit the paging response message to the base station 105 based on an access node priority for responding to the paging message, a link quality of the first wireless connection, or a channel quality of a channel between the UE 115-c and the base station 105.

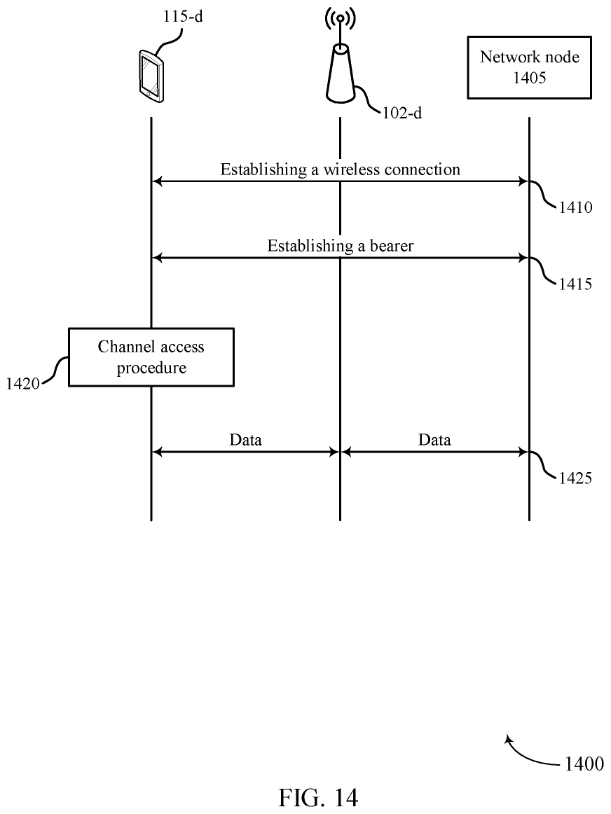

FIG. 14 illustrates an example of a process flow 1400 that supports control plane operation for disaggregated RAN in accordance with aspects of the present disclosure. The process flow 1400 includes a UE 115-d, which may be an example of a UE 115 described with reference to FIGS. 1-13. The process flow 1400 also includes an access point 102-d, which may be an example of an access point 102 described with reference to FIGS. 1-13. The process flow 1400 also includes a network node 1405, which may be an example of a network node (e.g., a CU or a WT node) described with reference to FIGS. 1-13. The UE 115-b may support communications via one or more RATs, including LTE, 5G, or WLAN. The UE 115-b may support LTE or 5G communications with a base station 105, and the UE 115-b may support WLAN communications with the access point 102-b. In addition, the network node 1405 may be associated with an operator network of the first RAT.

The process flow 1400 may implement aspects of the wireless communications system 100 or the wireless communications system 900. For example, the process flow 1400 may support efficient techniques for facilitating discovery of WLAN access points and communications over a WLAN with control plane termination in an 5G RAN. In the following description of the process flow 1400, the signaling exchanged between the UE 115-d, the access point 102-d, and the network node 1405 may be exchanged in a different order than the example order shown, or the operations performed by the UE 115-d, the access point 102-d, or the network node 1405 may be performed in different orders or at different times. Some operations may also be omitted from the process flow 1400, and other operations may be added to the process flow 1400.

At 1410, the network node 1405 and the UE 115-d configured for communications via the first RAT and the second RAT may establish a wireless connection. At 1415, the network node 1405 and the UE 115-d may establish a bearer associated with a traffic characteristic over the wireless connection. At 1420, the UE 115-d may perform a channel access procedure for a channel associated with the second RAT for communicating or exchanging data with the access point 102-d via a wireless connection with the access point 102-d based on an access category of the second RAT. The access category of the second RAT may be determined based on the traffic characteristic and a mapping rule between the traffic characteristic and the access category. In some cases, the traffic characteristic includes an identifier of the bearer, at least one logical channel associated with the bearer, a QoS profile of the bearer, an access class of the UE 115-d, or an establishment cause of the second wireless connection.

At 1425, the UE 115-d may exchange data with the access point 102-d and the network node 1405 via the wireless connection with the access point 102-d. As an example, for downlink transmissions, the network node 1405 may send data associated with the bearer to the access point 102-d associated with the second RAT for transmission to the UE 115-d. The data may be associated with a traffic characteristic for transmission via the bearer, and the data may be transmitted by the access point 102-d to the UE 115-d according to an access category for the second RAT that is mapped from the traffic characteristic. In some cases, the network node 1405 may map the traffic characteristic (e.g., associated with the first RAT) to the access category for the second RAT. In some cases, the network node 1305 may encapsulate the data in a packet, where a header of the packet includes the access category. In some cases, the network node 1405 may append the traffic characteristic to the data associated with the bearer. For uplink transmissions, the UE 115-b may map a traffic characteristic (e.g., associated with the first RAT) to an access category for the second RAT.

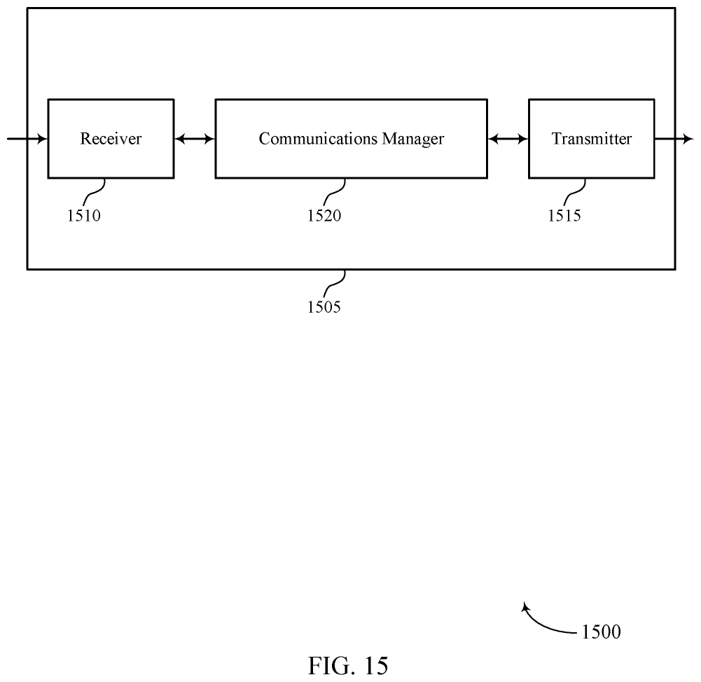

FIG. 15 shows a block diagram 1500 of a device 1505 that supports control plane operation for disaggregated RAN in accordance with aspects of the present disclosure. The device 1505 may be an example of aspects of a UE 115 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to control plane operation for disaggregated RAN). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to control plane operation for disaggregated RAN). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of control plane operation for disaggregated RAN as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication in accordance with examples as disclosed herein. For example, the communications manager 1520 may be configured as or otherwise support a means for establishing, by a UE, a first connection with a node of an operator network via an access point, wherein the operator network is associated with a first type of wireless communications and the access point is associated with a second type of wireless communications, and where the access point is selected from a set of access points based on the operator network and information associating the operator network with the access point. The communications manager 1520 may be configured as or otherwise support a means for communicating with the node of the operator network via the access point based on establishing the first connection with the node of the operator network.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for more efficient utilization of communication resources. In particular, because a UE may be able to discover a WLAN access point with control plane termination in 5G RAN, the UE may be able to receive system information, paging, and potentially other messages over WLAN. As such, the overhead over other interfaces may be reduced resulting in more efficient utilization of communication resources. Further, because a mapping may be defined from a traffic characteristic of a bearer established over a 5G wireless connection to an access category for communications over a WLAN, a UE and a network node may account for QoS requirements for communications over a WLAN which may also result in more efficient utilization of communication resources.

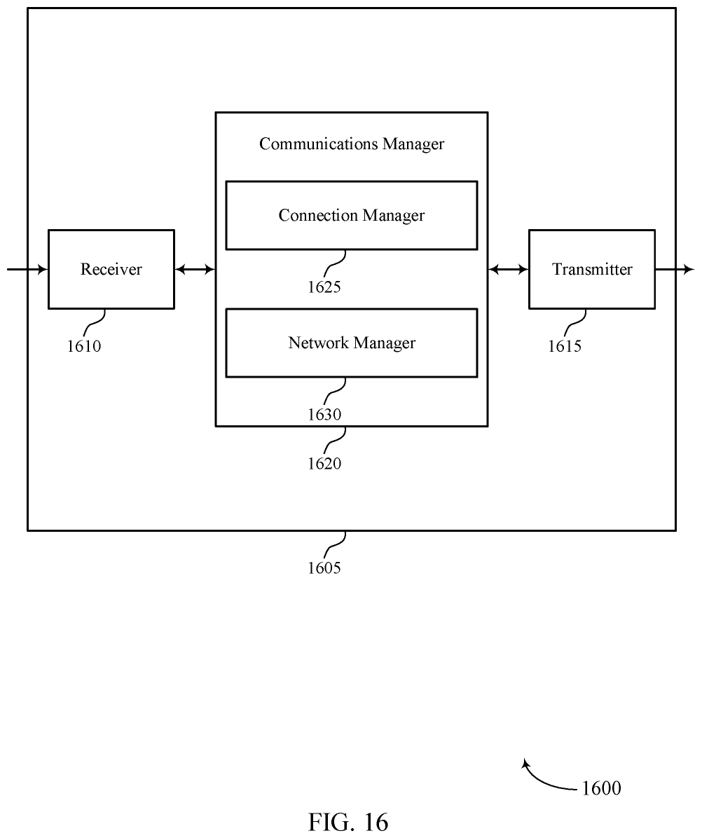

FIG. 16 shows a block diagram 1600 of a device 1605 that supports control plane operation for disaggregated RAN in accordance with aspects of the present disclosure. The device 1605 may be an example of aspects of a device 1505 or a UE 115 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to control plane operation for disaggregated RAN). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to control plane operation for disaggregated RAN). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of control plane operation for disaggregated RAN as described herein. For example, the communications manager 1620 may include a connection manager 1625 a network manager 1630, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication in accordance with examples as disclosed herein. The connection manager 1625 may be configured as or otherwise support a means for establishing, by a UE, a first connection with a node of an operator network via an access point, wherein the operator network is associated with a first type of wireless communications and the access point is associated with a second type of wireless communications, and where the access point is selected from a set of access points based on the operator network and information associating the operator network with the access point. The network manager 1630 may be configured as or otherwise support a means for communicating with the node of the operator network via the access point based on establishing the first connection with the node of the operator network.

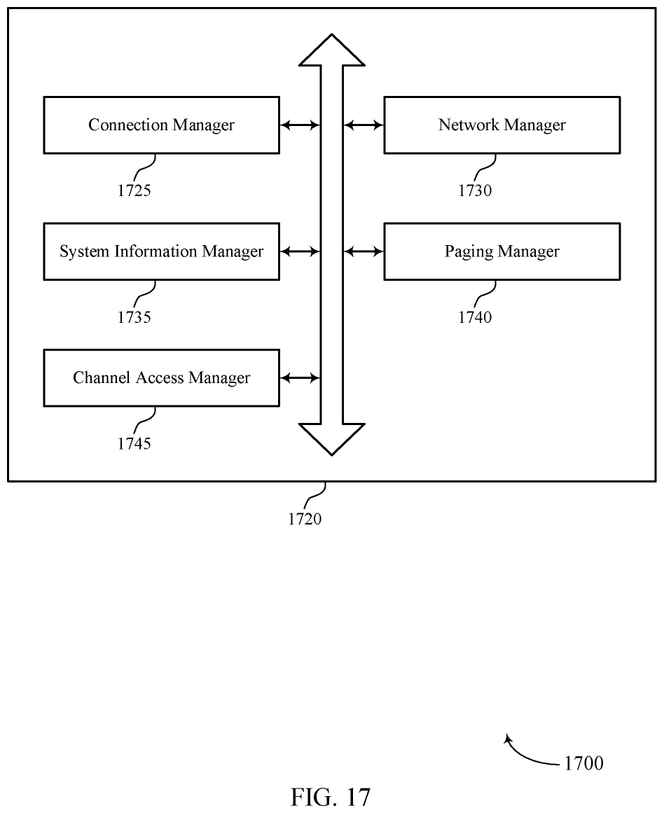

FIG. 17 shows a block diagram 1700 of a communications manager 1720 that supports control plane operation for disaggregated RAN in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of control plane operation for disaggregated RAN as described herein. For example, the communications manager 1720 may include a connection manager 1725, a network manager 1730, a system information manager 1735, a paging manager 1740, a channel access manager 1745, or any combination thereof. Each of these components may communicate, directly or indirectly, with one another (e.g., via one or more buses).

The communications manager 1720 may support wireless communication in accordance with examples as disclosed herein. The connection manager 1725 may be configured as or otherwise support a means for establishing, by a UE, a first connection with a node of an operator network via an access point, wherein the operator network is associated with a first type of wireless communications and the access point is associated with a second type of wireless communications, and where the access point is selected from a set of access points based on the operator network and information associating the operator network with the access point. The network manager 1730 may be configured as or otherwise support a means for communicating with the node of the operator network via the access point based on establishing the first connection with the node of the operator network.

In some examples, the network manager may be configured as or otherwise support a means for transmitting, from the UE to the access point, an address associated with the node of the operator network for control plane termination for the UE for the first type of wireless communications.

In some examples, the UE is configured with respective sets of identifiers associated with the second type of wireless communications for each of a set of multiple operator networks.

In some examples, the network manager 1730 may be configured as or otherwise support a means for receiving a configuration message from the node of the operator network including at least one updated set of identifiers for the respective sets of identifiers.

In some examples, the configuration message is received from a base station associated with the first type of wireless communications or the access point.

In some examples, the system information manager 1735 may be configured as or otherwise support a means for receiving, from the access point, system information associating the operator network and the access point.

In some examples, establishing the first connection with the node is based on receiving the system information.

In some examples, the system information includes an indicator of a duration for a system information modification period or a starting time for the system information modification period, and the system information manager 1735 may be configured as or otherwise support a means for monitoring for updated system information from the access point based on the indicator.

In some examples, the system information includes an indicator of a modification time for the system information, and the system information manager 1735 may be configured as or otherwise support a means for monitoring for updated system information from the access point based on the indicator.

In some examples, the system information manager 1735 may be configured as or otherwise support a means for receiving second system information from a base station associated with the operator network. In some examples, the connection manager 1725 may be configured as or otherwise support a means for establishing a second connection with the base station based on the system information or the second system information.

In some examples, to support establishing the second connection, the system information manager 1735 may be configured as or otherwise support a means for selecting one of the system information or the second system information for the second connection based on a link priority for receiving system information.

In some examples, to support establishing the second connection, the system information manager 1735 may be configured as or otherwise support a means for overwriting a portion of the system information based on the second system information.

In some examples, the paging manager 1740 may be configured as or otherwise support a means for receiving a broadcast message from the access point, the broadcast message including a paging message associated with the first type of wireless communications. In some examples, the paging manager 1740 may be configured as or otherwise support a means for responding to the paging message based on decoding the paging message.

In some examples, to support responding to the paging message, the paging manager 1740 may be configured as or otherwise support a means for transmitting a packet including an encapsulated paging response message to the node of the operator network via the access point or transmitting a paging response message to a base station associated with the operator network.

In some examples, the paging manager 1740 may be configured as or otherwise support a means for determining whether to transmit the packet including the encapsulated paging response message to the access point or to transmit the paging response message to the base station based on an access node priority for responding to the paging message, a link quality of the first connection, a channel quality of a channel between the UE and the base station, or a combination thereof.

In some examples, the connection manager 1725 may be configured as or otherwise support a means for establishing a second connection to a base station associated with the operator network. In some examples, the connection manager 1725 may be configured as or otherwise support a means for establishing a bearer associated with a traffic characteristic over the second connection. In some examples, the channel access manager 1745 may be configured as or otherwise support a means for performing a channel access procedure for a channel associated with the second type of wireless communications for communicating data to the access point via the first connection based on an access category of the second type of wireless communications, the access category determined based on the traffic characteristic and a mapping rule between the traffic characteristic and the access category.

In some examples, the traffic characteristic includes information an identifier of the bearer, at least one logical channel associated with the bearer, a quality of service profile of the bearer, an access class of the UE, or an establishment cause of the second connection.

In some examples, the network manager 1730 may be configured as or otherwise support a means for receiving, from the access point, an indicator of one or more operator networks supported by the access point for control plane communications associated with the first type of wireless communications, where connecting to the access point is based on receiving the indicator of one or more operator networks including the operator network.

In some examples, the second type of wireless communications includes a WLAN, and the operator network includes a public land mobile network (PLMN).

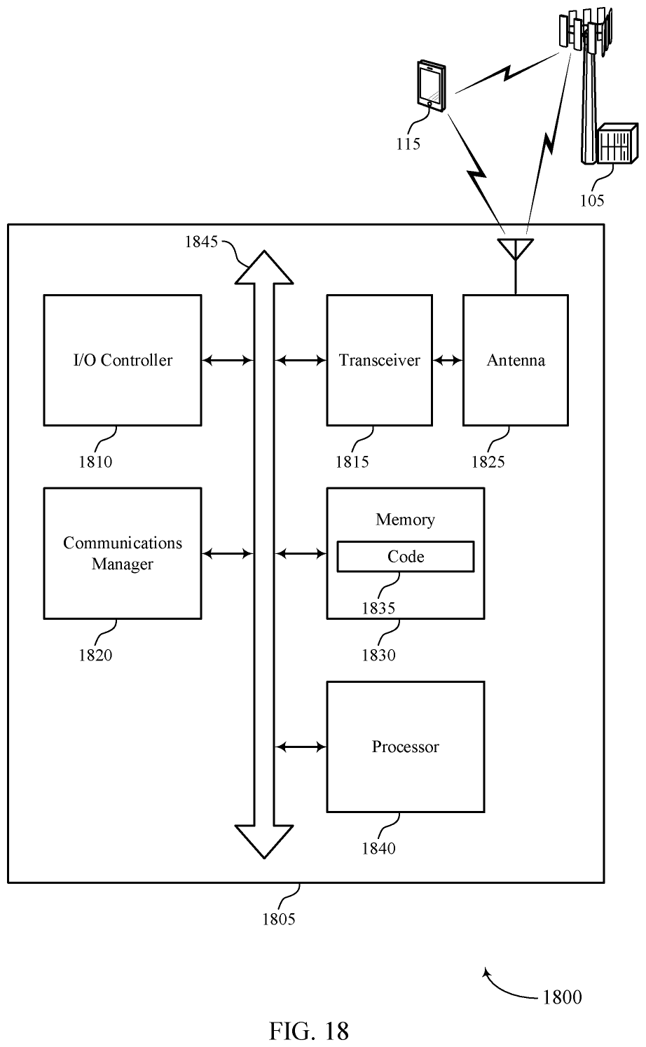

FIG. 18 shows a diagram of a system 1800 including a device 1805 that supports control plane operation for disaggregated RAN in accordance with aspects of the present disclosure. The device 1805 may be an example of or include the components of a device 1505, a device 1605, or a UE 115 as described herein. The device 1805 may communicate wirelessly with one or more base stations 105, UEs 115, or any combination thereof. The device 1805 may include components for bi-directional voice and data communications including components for transmitting and receiving communications, such as a communications manager 1820, an input/output (I/O) controller 1810, a transceiver 1815, an antenna 1825, a memory 1830, code 1835, and a processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of a processor, such as the processor 1840. In some cases, a user may interact with the device 1805 via the I/O controller 1810 or via hardware components controlled by the I/O controller 1810.

In some cases, the device 1805 may include a single antenna 1825. However, in some other cases, the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include random access memory (RAM) and read-only memory (ROM). The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a basic I/O system (BIOS) which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting control plane operation for disaggregated RAN). For example, the device 1805 or a component of the device 1805 may include a processor 1840 and memory 1830 coupled to the processor 1840, the processor 1840 and memory 1830 configured to perform various functions described herein.

The communications manager 1820 may support wireless communication in accordance with examples as disclosed herein. For example, the communications manager 1820 may be configured as or otherwise support a means for establishing, by a UE, a first connection with a node of an operator network via an access point, wherein the operator network is associated with a first type of wireless communications and the access point is associated with a second type of wireless communications, and where the access point is selected from a set of access points based on the operator network and information associating the operator network with the access point. The communications manager 1820 may be configured as or otherwise support a means for communicating with the node of the operator network via the access point based on establishing the first connection with the node of the operator network.

By including or configuring the communications manager 1820 in accordance with examples as described herein, the device 1805 may support techniques for more efficient utilization of communication resources. In particular, because a UE may be able to discover a WLAN access point with control plane termination in 5G RAN, the UE may be able to receive system information, paging, and potentially other messages over WLAN. As such, the overhead over other interfaces may be reduced resulting in more efficient utilization of communication resources. Further, because a mapping may be defined from a traffic characteristic of a bearer established over a 5G connection to an access category for communications over a WLAN, a UE and a network node may account for QoS requirements for communications over a WLAN which may also result in more efficient utilization of communication resources.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of control plane operation for disaggregated RAN as described herein, or the processor 1840 and the memory 1830 may be otherwise configured to perform or support such operations.

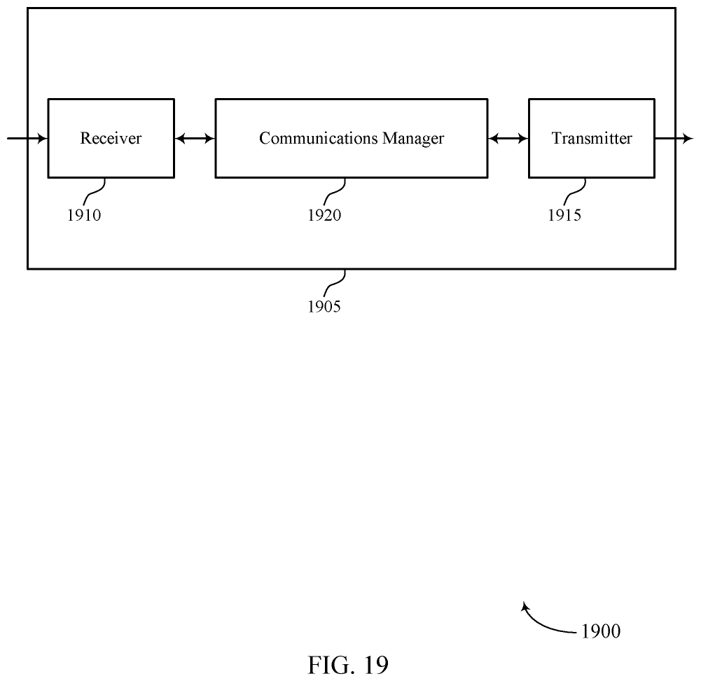

FIG. 19 shows a block diagram 1900 of a device 1905 that supports control plane operation for disaggregated RAN in accordance with aspects of the present disclosure. The device 1905 may be an example of aspects of a Network Entity—ALPHA as described herein. The device 1905 may include a receiver 1910, a transmitter 1915, and a communications manager 1920. The device 1905 may also include a processor. Each of these components may be in communication with one another (e.g., via one or more buses).

The receiver 1910 may provide a means for receiving information such as packets, user data, control information, or any combination thereof associated with various information channels (e.g., control channels, data channels, information channels related to control plane operation for disaggregated RAN). Information may be passed on to other components of the device 1905. The receiver 1910 may utilize a single antenna or a set of multiple antennas.

The transmitter 1915 may provide a means for transmitting signals generated by other components of the device 1905. For example, the transmitter 1915 may transmit information such as packets, user data, control information, or any combination thereof associated with various information channels (e.g., control channels, data channels, information channels related to control plane operation for disaggregated RAN). In some examples, the transmitter 1915 may be co-located with a receiver 1910 in a transceiver module. The transmitter 1915 may utilize a single antenna or a set of multiple antennas.

The communications manager 1920, the receiver 1910, the transmitter 1915, or various combinations thereof or various components thereof may be examples of means for performing various aspects of control plane operation for disaggregated RAN as described herein. For example, the communications manager 1920, the receiver 1910, the transmitter 1915, or various combinations or components thereof may support a method for performing one or more of the functions described herein.

In some examples, the communications manager 1920, the receiver 1910, the transmitter 1915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1920, the receiver 1910, the transmitter 1915, or various combinations or components thereof may be implemented in code (e.g., as communications management software or firmware) executed by a processor. If implemented in code executed by a processor, the functions of the communications manager 1920, the receiver 1910, the transmitter 1915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1920 may be configured to perform various operations (e.g., receiving, monitoring, transmitting) using or otherwise in cooperation with the receiver 1910, the transmitter 1915, or both. For example, the communications manager 1920 may receive information from the receiver 1910, send information to the transmitter 1915, or be integrated in combination with the receiver 1910, the transmitter 1915, or both to receive information, transmit information, or perform various other operations as described herein.

The communications manager 1920 may support wireless communication in accordance with examples as disclosed herein. For example, the communications manager 1920 may be configured as or otherwise support a means for encapsulating, by a network node associating with an operator network of a first type of wireless communications, a paging message for a UE configured for communications via the first type of wireless communications and a second type of wireless communications. The communications manager 1920 may be configured as or otherwise support a means for sending, by the network node, a packet including the encapsulated paging message to an access point associated with the second type of wireless communications. The communications manager 1920 may be configured as or otherwise support a means for receiving, by the network node, a paging response message from the UE.

For example, the communications manager 1920 may be configured as or otherwise support a means for establishing, by a network node associated with an operator network of a first type of wireless communications, a connection to a UE configured for communications via the first type of wireless communications and a second type of wireless communications. The communications manager 1920 may be configured as or otherwise support a means for establishing a bearer over the connection. The communications manager 1920 may be configured as or otherwise support a means for sending data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

By including or configuring the communications manager 1920 in accordance with examples as described herein, the device 1905 (e.g., a processor controlling or otherwise coupled to the receiver 1910, the transmitter 1915, the communications manager 1920, or a combination thereof) may support techniques for more efficient utilization of communication resources. In particular, because a UE may be able to discover a WLAN access point with control plane termination in 5G RAN, the UE may be able to receive system information, paging, and potentially other messages over WLAN. As such, the overhead over other interfaces may be reduced resulting in more efficient utilization of communication resources. Further, because a mapping may be defined from a traffic characteristic of a bearer established over a 5G wireless connection to an access category for communications over a WLAN, a UE and a network node may account for QoS requirements for communications over a WLAN which may also result in more efficient utilization of communication resources.

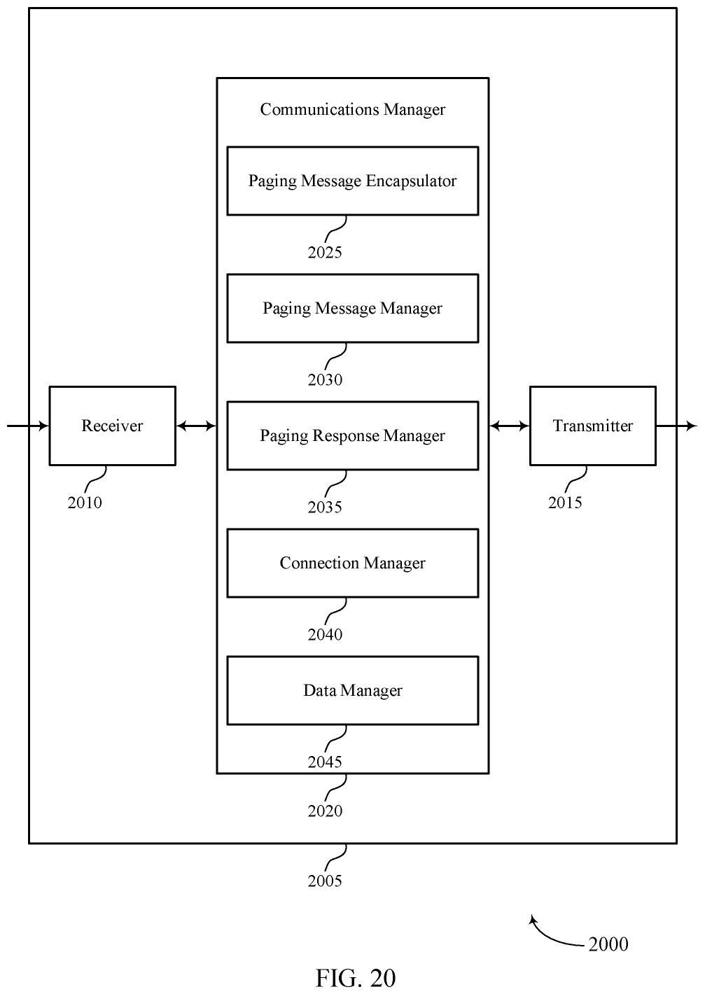

FIG. 20 shows a block diagram 2000 of a device 2005 that supports control plane operation for disaggregated RAN in accordance with aspects of the present disclosure. The device 2005 may be an example of aspects of a device 1905 or a Network Entity—ALPHA 115 as described herein. The device 2005 may include a receiver 2010, a transmitter 2015, and a communications manager 2020. The device 2005 may also include a processor. Each of these components may be in communication with one another (e.g., via one or more buses).

The receiver 2010 may provide a means for receiving information such as packets, user data, control information, or any combination thereof associated with various information channels (e.g., control channels, data channels, information channels related to control plane operation for disaggregated RAN). Information may be passed on to other components of the device 2005. The receiver 2010 may utilize a single antenna or a set of multiple antennas.

The transmitter 2015 may provide a means for transmitting signals generated by other components of the device 2005. For example, the transmitter 2015 may transmit information such as packets, user data, control information, or any combination thereof associated with various information channels (e.g., control channels, data channels, information channels related to control plane operation for disaggregated RAN). In some examples, the transmitter 2015 may be co-located with a receiver 2010 in a transceiver module. The transmitter 2015 may utilize a single antenna or a set of multiple antennas.

The device 2005, or various components thereof, may be an example of means for performing various aspects of control plane operation for disaggregated RAN as described herein. For example, the communications manager 2020 may include a paging message encapsulator 2025, a paging message manager 2030, a paging response manager 2035, a connection manager 2040, a data manager 2045, or any combination thereof. The communications manager 2020 may be an example of aspects of a communications manager 1920 as described herein. In some examples, the communications manager 2020, or various components thereof, may be configured to perform various operations (e.g., receiving, monitoring, transmitting) using or otherwise in cooperation with the receiver 2010, the transmitter 2015, or both. For example, the communications manager 2020 may receive information from the receiver 2010, send information to the transmitter 2015, or be integrated in combination with the receiver 2010, the transmitter 2015, or both to receive information, transmit information, or perform various other operations as described herein.

The communications manager 2020 may support wireless communication in accordance with examples as disclosed herein. The paging message encapsulator 2025 may be configured as or otherwise support a means for encapsulating, by a network node associated with an operator network of a first type of wireless communications, a paging message for a UE configured for communications via the first type of wireless communications and a second type of wireless communications. The paging message manager 2030 may be configured as or otherwise support a means for sending, by the network node, a packet including the encapsulated paging message to an access point associated with the second type of wireless communications. The paging response manager 2035 may be configured as or otherwise support a means for receiving, by the network node, a paging response message from the UE.

The connection manager 2040 may be configured as or otherwise support a means for establishing, by a network node associated with an operator network of a first type of wireless communications, a connection to a UE configured for communications via the first type of wireless communications and a second type of wireless communications. The connection manager 2040 may be configured as or otherwise support a means for establishing a bearer over the connection. The data manager 2045 may be configured as or otherwise support a means for sending data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

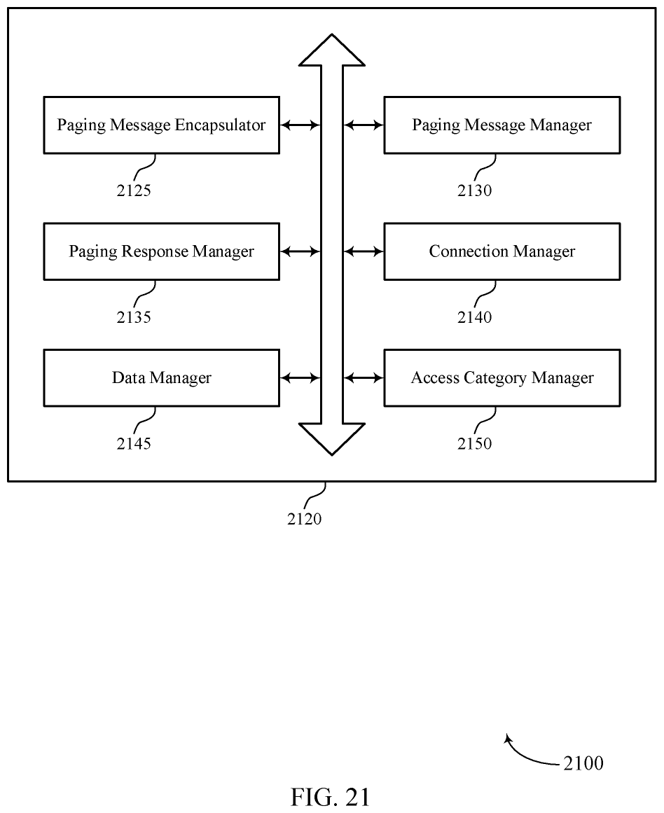

FIG. 21 shows a block diagram 2100 of a communications manager 2120 that supports control plane operation for disaggregated RAN in accordance with aspects of the present disclosure. The communications manager 2120 may be an example of aspects of a communications manager 1920, a communications manager 2020, or both, as described herein. The communications manager 2120, or various components thereof, may be an example of means for performing various aspects of control plane operation for disaggregated RAN as described herein. For example, the communications manager 2120 may include a paging message encapsulator 2125, a paging message manager 2130, a paging response manager 2135, a connection manager 2140, a data manager 2145, an access category manager 2150, or any combination thereof. Each of these components may communicate, directly or indirectly, with one another (e.g., via one or more buses).

The communications manager 2120 may support wireless communication in accordance with examples as disclosed herein. The paging message encapsulator 2125 may be configured as or otherwise support a means for encapsulating, by a network node associated with an operator network of a first type of wireless communications, a paging message for a UE configured for communications via the first type of wireless communications and a second type of wireless communications. The paging message manager 2130 may be configured as or otherwise support a means for sending, by the network node, a packet including the encapsulated paging message to an access point associated with the second type of wireless communications. The paging response manager 2135 may be configured as or otherwise support a means for receiving, by the network node, a paging response message from the UE.

In some examples, to support encapsulating the paging message, the paging message encapsulator 2125 may be configured as or otherwise support a means for setting a destination address of the packet to an indicator that indicates to the access point to broadcast the packet.

In some examples, to support encapsulating the paging message, the paging message encapsulator 2125 may be configured as or otherwise support a means for setting a source address of the packet to an address of the network node.

In some examples, to support encapsulating the paging message, the paging message encapsulator 2125 may be configured as or otherwise support a means for sending an address of the UE to the access point with the packet.

In some examples, to support encapsulating the paging message, the paging message encapsulator 2125 may be configured as or otherwise support a means for setting a destination address of the packet to an address of the UE.

In some examples, to support encapsulating the paging message, the paging message encapsulator 2125 may be configured as or otherwise support a means for obtaining the address of the UE from a core node of the first type of wireless communications or from a stored context associated with the UE.

In some examples, the paging message manager 2130 may be configured as or otherwise support a means for determining to send the encapsulated paging message to the access point based on a predetermined paging policy, a paging policy received from a core node of the first type of wireless communications, a failure to receive a paging response from the UE after transmitting a prior paging message to the UE over a cell associated with the first type of wireless communications, a category of the UE, comparing a discontinuous reception cycle value associated with the UE and a threshold, a connection state of the UE, a characteristic of a protocol data unit including data associated with a paging request received from the core node, a quality of service of the data associated with the paging request, receiving an address of the UE in the paging request, or a combination thereof.

The connection manager 2140 may be configured as or otherwise support a means for establishing, by a network node associated with an operator network of a first type of wireless communications, a connection to a UE configured for communications via the first type of wireless communications and a second type of wireless communications. In some examples, the connection manager 2140 may be configured as or otherwise support a means for establishing a bearer over the connection. The data manager 2145 may be configured as or otherwise support a means for sending data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

In some examples, to support sending the data associated with the bearer to the access point, the access category manager 2150 may be configured as or otherwise support a means for mapping the traffic characteristic to the access category for the second type of wireless communications.

In some examples, to support sending the data associated with the bearer to the access point, the data manager 2145 may be configured as or otherwise support a means for encapsulating the data in a packet, where a header of the packet includes the access category.

In some examples, to support sending the data associated with the bearer to the access point, the data manager 2145 may be configured as or otherwise support a means for appending the traffic characteristic to the data associated with the bearer.

In some examples, the traffic characteristic includes an identifier of the bearer, at least one logical channel associated with the bearer, a quality of service profile of the bearer, an access class of the UE, or an establishment cause of the connection.

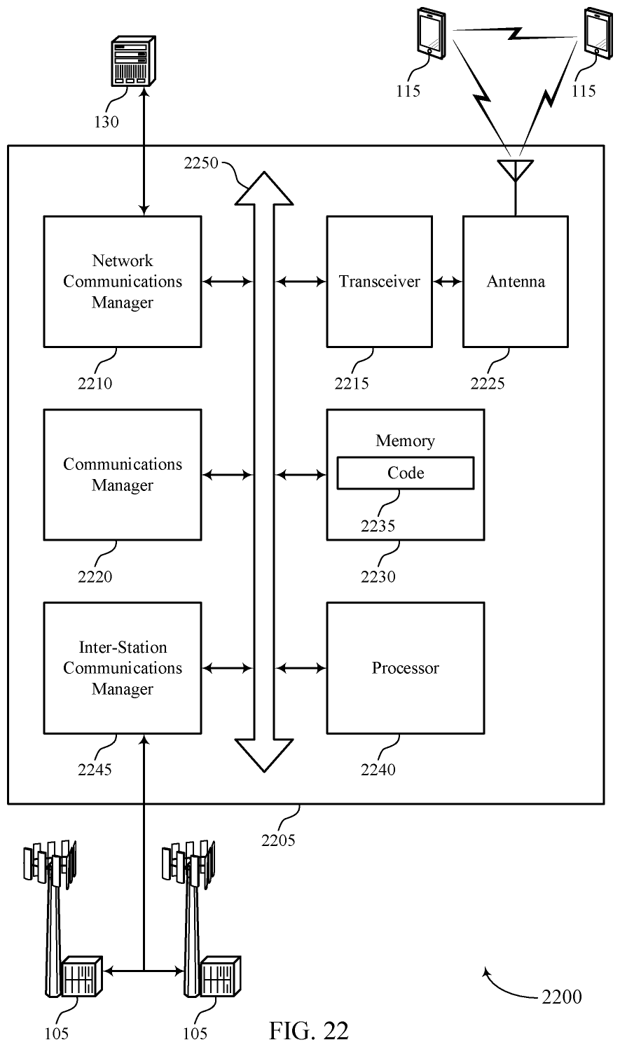

FIG. 22 shows a diagram of a system 2200 including a device 2205 that supports control plane operation for disaggregated RAN in accordance with aspects of the present disclosure. The device 2205 may be an example of or include the components of a device 1905, a device 2005, or a Network Entity—ALPHA as described herein. The device 2205 may include components for bi-directional voice and data communications including components for transmitting and receiving communications, such as a communications manager 2220, a network communications manager 2210, a transceiver 2215, an antenna 2225, a memory 2230, code 2235, a processor 2240, and an inter-station communications manager 2245. These components may be in electronic communication or otherwise coupled (e.g., operatively, communicatively, functionally, electronically, electrically) via one or more buses (e.g., a bus 2250).

The network communications manager 2210 may manage communications with a core network 130 (e.g., via one or more wired backhaul links). For example, the network communications manager 2210 may manage the transfer of data communications for client devices, such as one or more UEs 115.

In some cases, the device 2205 may include a single antenna 2225. However, in some other cases the device 2205 may have more than one antenna 2225, which may be capable of concurrently transmitting or receiving multiple wireless transmissions. The transceiver 2215 may communicate bi-directionally, via the one or more antennas 2225, wired, or wireless links as described herein. For example, the transceiver 2215 may represent a wireless transceiver and may communicate bi-directionally with another wireless transceiver. The transceiver 2215 may also include a modem to modulate the packets, to provide the modulated packets to one or more antennas 2225 for transmission, and to demodulate packets received from the one or more antennas 2225. The transceiver 2215, or the transceiver 2215 and one or more antennas 2225, may be an example of a transmitter 1915, a transmitter 2015, a receiver 1910, a receiver 2010, or any combination thereof or component thereof, as described herein.

The memory 2230 may include RAM and ROM. The memory 2230 may store computer-readable, computer-executable code 2235 including instructions that, when executed by the processor 2240, cause the device 2205 to perform various functions described herein. The code 2235 may be stored in a non-transitory computer-readable medium such as system memory or another type of memory. In some cases, the code 2235 may not be directly executable by the processor 2240 but may cause a computer (e.g., when compiled and executed) to perform functions described herein. In some cases, the memory 2230 may contain, among other things, a BIOS which may control basic hardware or software operation such as the interaction with peripheral components or devices.

The processor 2240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2240 may be configured to operate a memory array using a memory controller. In some other cases, a memory controller may be integrated into the processor 2240. The processor 2240 may be configured to execute computer-readable instructions stored in a memory (e.g., the memory 2230) to cause the device 2205 to perform various functions (e.g., functions or tasks supporting control plane operation for disaggregated RAN). For example, the device 2205 or a component of the device 2205 may include a processor 2240 and memory 2230 coupled to the processor 2240, the processor 2240 and memory 2230 configured to perform various functions described herein.

The inter-station communications manager 2245 may manage communications with other base stations 105, and may include a controller or scheduler for controlling communications with UEs 115 in cooperation with other base stations 105. For example, the inter-station communications manager 2245 may coordinate scheduling for transmissions to UEs 115 for various interference mitigation techniques such as beamforming or joint transmission. In some examples, the inter-station communications manager 2245 may provide an X2 interface within an LTE/LTE-A wireless communications network technology to provide communication between base stations 105.

The communications manager 2220 may support wireless communication in accordance with examples as disclosed herein. For example, the communications manager 2220 may be configured as or otherwise support a means for encapsulating, by a network node associating with an operator network of a first type of wireless communications, a paging message for a UE configured for communications via the first type of wireless communications and a second type of wireless communications. The communications manager 2220 may be configured as or otherwise support a means for sending, by the network node, a packet including the encapsulated paging message to an access point associated with the second type of wireless communications. The communications manager 2220 may be configured as or otherwise support a means for receiving, by the network node, a paging response message from the UE.

For example, the communications manager 2220 may be configured as or otherwise support a means for establishing, by a network node associated with an operator network of a first type of wireless communications, a connection to a UE configured for communications via the first type of wireless communications and a second type of wireless communications. The communications manager 2220 may be configured as or otherwise support a means for establishing a bearer over the connection. The communications manager 2220 may be configured as or otherwise support a means for sending data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic.

By including or configuring the communications manager 2220 in accordance with examples as described herein, the device 2205 may support techniques for more efficient utilization of communication resources. In particular, because a UE may be able to discover a WLAN access point with control plane termination in 5G RAN, the UE may be able to receive system information, paging, and potentially other messages over WLAN. As such, the overhead over other interfaces may be reduced resulting in more efficient utilization of communication resources. Further, because a mapping may be defined from a traffic characteristic of a bearer established over a 5G wireless connection to an access category for communications over a WLAN, a UE and a network node may account for QoS requirements for communications over a WLAN which may also result in more efficient utilization of communication resources.

In some examples, the communications manager 2220 may be configured to perform various operations (e.g., receiving, monitoring, transmitting) using or otherwise in cooperation with the transceiver 2215, the one or more antennas 2225, or any combination thereof. Although the communications manager 2220 is illustrated as a separate component, in some examples, one or more functions described with reference to the communications manager 2220 may be supported by or performed by the processor 2240, the memory 2230, the code 2235, or any combination thereof. For example, the code 2235 may include instructions executable by the processor 2240 to cause the device 2205 to perform various aspects of control plane operation for disaggregated RAN as described herein, or the processor 2240 and the memory 2230 may be otherwise configured to perform or support such operations.

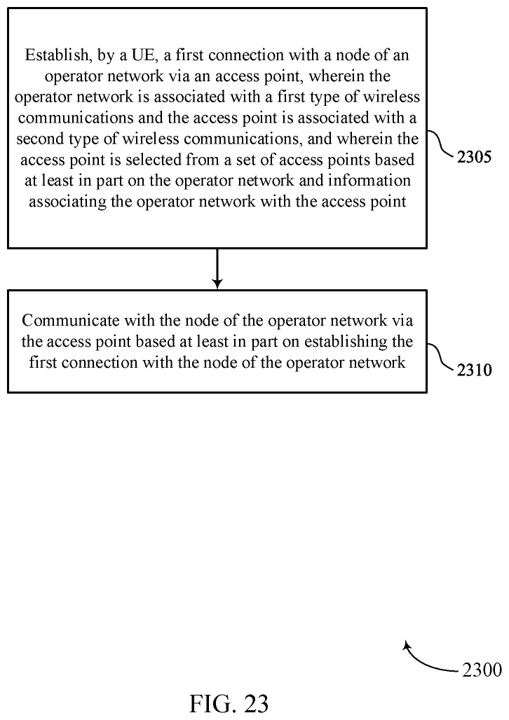

FIG. 23 shows a flowchart illustrating a method 2300 that supports control plane operation for disaggregated RAN in accordance with aspects of the present disclosure. The operations of the method 2300 may be implemented by a UE or its components as described herein. For example, the operations of the method 2300 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

At 2305, the method may include establishing, by a UE, a first connection with a node of an operator network via an access point, wherein the operator network is associated with a first type of wireless communications and the access point is associated with a second type of wireless communications, and where the access point is selected from a set of access points based on the operator network and information associating the operator network with the access point. The operations of 2305 may be performed in accordance with examples as disclosed herein. In some examples, aspects of the operations of 2305 may be performed by a connection manager 1725 as described with reference to FIG. 17.

At 2310, the method may include communicating with the node of the operator network via the access point based on establishing the first connection with the node of the operator network. The operations of 2310 may be performed in accordance with examples as disclosed herein. In some examples, aspects of the operations of 2310 may be performed by a network manager 1730 as described with reference to FIG. 17.

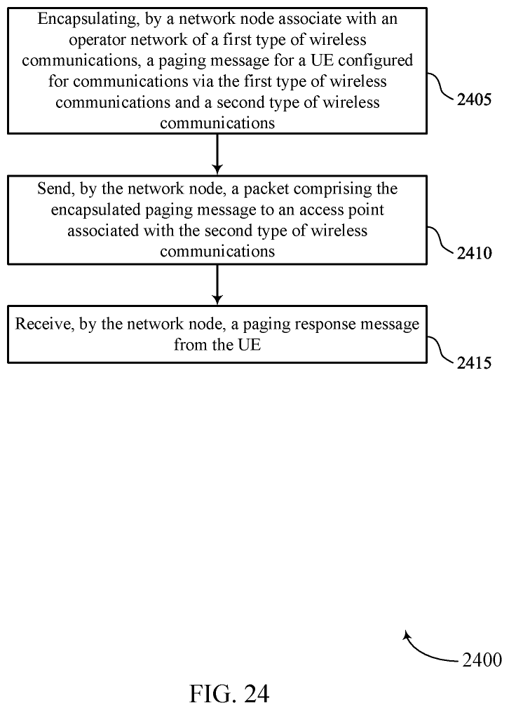

FIG. 24 shows a flowchart illustrating a method 2400 that supports control plane operation for disaggregated RAN in accordance with aspects of the present disclosure. The operations of the method 2400 may be implemented by a Network Entity—ALPHA or its components as described herein. For example, the operations of the method 2400 may be performed by a Network Entity—ALPHA as described with reference to FIGS. 1 through 14 and 19 through 22. In some examples, a Network Entity
ALPHA may execute a set of instructions to control the functional elements of the Network Entity—ALPHA to perform the described functions. Additionally, or alternatively, the Network Entity—ALPHA may perform aspects of the described functions using special-purpose hardware.

At 2405, the method may include encapsulating, by a network node associated with an operator network of a first type of wireless communications, a paging message for a UE configured for communications via the first type of wireless communications and a second type of wireless communications. The operations of 2405 may be performed in accordance with examples as disclosed herein. In some examples, aspects of the operations of 2405 may be performed by a paging message encapsulator 2125 as described with reference to FIG. 21.

At 2410, the method may include sending, by the network node, a packet including the encapsulated paging message to an access point associated with the second type of wireless communications. The operations of 2410 may be performed in accordance with examples as disclosed herein. In some examples, aspects of the operations of 2410 may be performed by a paging message manager 2130 as described with reference to FIG. 21.

At 2415, the method may include receiving, by the network node, a paging response message from the UE. The operations of 2415 may be performed in accordance with examples as disclosed herein. In some examples, aspects of the operations of 2415 may be performed by a paging response manager 2135 as described with reference to FIG. 21.

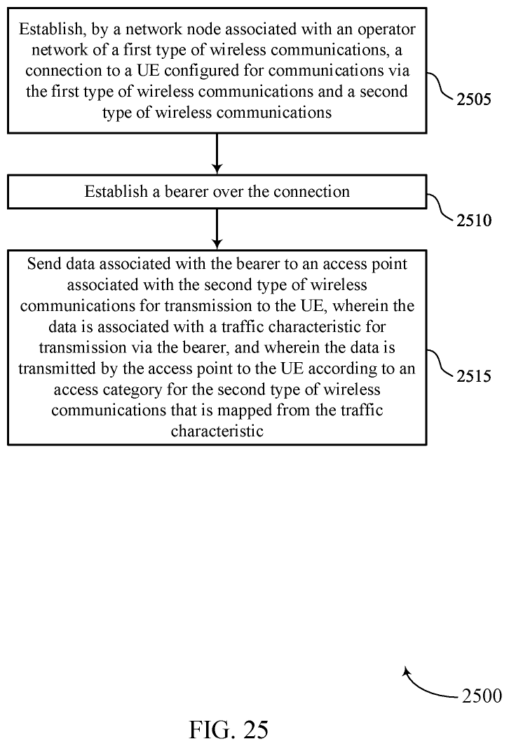

FIG. 25 shows a flowchart illustrating a method 2500 that supports control plane operation for disaggregated RAN in accordance with aspects of the present disclosure. The operations of the method 2500 may be implemented by a Network Entity—ALPHA or its components as described herein. For example, the operations of the method 2500 may be performed by a Network Entity—ALPHA as described with reference to FIGS. 1 through 14 and 19 through 22. In some examples, a Network Entity —ALPHA may execute a set of instructions to control the functional elements of the Network Entity—ALPHA to perform the described functions. Additionally, or alternatively, the Network Entity—ALPHA may perform aspects of the described functions using special-purpose hardware.

At 2505, the method may include establishing, by a network node associated with an operator network of a first type of wireless communications, a connection to a UE configured for communications via the first type of wireless communications and a second type of wireless communications. The operations of 2505 may be performed in accordance with examples as disclosed herein. In some examples, aspects of the operations of 2505 may be performed by a connection manager 2140 as described with reference to FIG. 21.

At 2510, the method may include establishing a bearer over the connection. The operations of 2510 may be performed in accordance with examples as disclosed herein. In some examples, aspects of the operations of 2510 may be performed by a connection manager 2140 as described with reference to FIG. 21.

At 2515, the method may include sending data associated with the bearer to an access point associated with the second type of wireless communications for transmission to the UE, where the data is associated with a traffic characteristic for transmission via the bearer, and where the data is transmitted by the access point to the UE according to an access category for the second type of wireless communications that is mapped from the traffic characteristic. The operations of 2515 may be performed in accordance with examples as disclosed herein. In some examples, aspects of the operations of 2515 may be performed by a data manager 2145 as described with reference to FIG. 21.

The following provides an overview of aspects of the present disclosure:
Aspect 1: A method for wireless communication, comprising: establishing, by a UE, a first connection with a node of an operator network via an access point, wherein the operator network is associated with a first type of wireless communications and the access point is associated with a second type of wireless communications, and wherein the access point is selected from a set of access points based at least in part on the operator network and information associating the operator network with the access point; and communicate with the node of the operator network via the access point based at least in part on establishing the first connection with the node of the operator network.
Aspect 2: The method of aspect 1, further comprising transmitting, from the UE to the access point, an address associated with the node of the operator network for control plane termination for the UE for the first type of wireless communications.
Aspect 3: The method of any of aspects 1 through 2, wherein the UE is configured with respective sets of identifiers associated with the second type of wireless communications for each of a plurality of operator networks.
Aspect 4: The method of aspect 3, further comprising receiving a configuration message from the node of the operator network comprising at least one updated set of identifiers for the respective sets of identifiers.
Aspect 5: The method of aspect 4, wherein the configuration message is received from a base station associated with the first type of wireless communications or the access point.
Aspect 6: The method of any of aspects 1 through 5, further comprising receiving, from the access point, system information associating the operator network and the access point.
Aspect 7: The method of aspect 6, wherein establishing the first connection with the node is based at least in part on receiving the system information.
Aspect 8: The method of any of aspects 6 through 7, wherein the system information comprises an indicator of a duration for a system information modification period or a starting time for the system information modification period, the method further comprising: monitoring for updated system information from the access point based at least in part on the indicator.
Aspect 9: The method of any of aspects 6 through 8, wherein the system information comprises an indicator of a modification time for the system information, the method further comprising monitoring for updated system information from the access point based at least in part on the indicator.
Aspect 10: The method of any of aspects 6 through 9, further comprising: receiving second system information from a base station associated with the operator network; and establishing a second connection with the base station based at least in part on the system information or the second system information.
Aspect 11: The method of aspect 10, wherein establishing the second connection comprises: selecting one of the system information or the second system information for the second connection based at least in part on a link priority for receiving system information.
Aspect 12: The method of any of aspects 10 through 11, wherein establishing the second connection comprises: overwriting a portion of the system information based at least in part on the second system information.
Aspect 13: The method of any of aspects 1 through 12, further comprising: receiving a broadcast message from the access point, the broadcast message comprising a paging message associated with the first type of wireless communications; and responding to the paging message based at least in part on decoding the paging message.
Aspect 14: The method of aspect 13, wherein responding to the paging message comprises transmitting a packet comprising an encapsulated paging response message to the node of the operator network via the access point or transmitting a paging response message to a base station associated with the operator network.
Aspect 15: The method of aspect 14, further comprising: determining whether to transmit the packet comprising the encapsulated paging response message to the access point or to transmit the paging response message to the base station based at least in part on an access node priority for responding to the paging message, a link quality of the first connection, a channel quality of a channel between the UE and the base station, or a combination thereof.
Aspect 16: The method of any of aspects 1 through 15, further comprising: establishing a second connection to a base station associated with the operator network; establishing a bearer associated with a traffic characteristic over the second connection; and performing a channel access procedure for a channel associated with the second type of wireless communications for communicating data to the access point via the first connection based at least in part on an access category of the second type of wireless communications, the access category determined based at least in part on the traffic characteristic and a mapping rule between the traffic characteristic and the access category.
Aspect 17: The method of aspect 16, wherein the traffic characteristic comprises information an identifier of the bearer, at least one logical channel associated with the bearer, a quality of service profile of the bearer, an access class of the UE, or an establishment cause of the second connection.
Aspect 18: The method of any of aspects 1 through 17, further comprising: receiving, from the access point, an indicator of one or more operator networks supported by the access point for control plane communications associated with the first type of wireless communications, wherein connecting to the access point is based at least in part on receiving the indicator of one or more operator networks comprising the operator network.
Aspect 19: A method for wireless communication, comprising: encapsulating, by a network node associated with an operator network of a first type of wireless communications, a paging message for a UE configured for communications via the first type of wireless communications and a second type of wireless communications; sending, by the network node, a packet comprising the encapsulated paging message to an access point associated with the second type of wireless communications; and receiving, by the network node, a paging response message from the UE.
Aspect 20: The method of aspect 19, wherein encapsulating the paging message comprises setting a destination address of the packet to an indicator that indicates to the access point to broadcast the packet.
Aspect 21: The method of any of aspects 19 through 20, wherein encapsulating the paging message comprises setting a source address of the packet to an address of the network node.
Aspect 22: The method of any of aspects 19 through 21, wherein encapsulating the paging message comprises sending an address of the UE to the access point with the packet.
Aspect 23: The method of any of aspects 19 through 22, wherein encapsulating the paging message comprises setting a destination address of the packet to an address of the UE.
Aspect 24: The method of aspect 23, wherein encapsulating the paging message comprises obtaining the address of the UE from a core node of the first type of wireless communications or from a stored context associated with the UE.
Aspect 25: The method of any of aspects 19 through 24, further comprising: determining to send the encapsulated paging message to the access point based at least in part on a predetermined paging policy, a paging policy received from a core node of the first type of wireless communications, a failure to receive a paging response from the UE after transmitting a prior paging message to the UE over a cell associated with the first type of wireless communications, a category of the UE, comparing a discontinuous reception cycle value associated with the UE and a threshold, a connection state of the UE, a characteristic of a protocol data unit comprising data associated with a paging request received from the core node, a quality of service of the data associated with the paging request, receiving an address of the UE in the paging request, or a combination thereof.
Aspect 26: A method, comprising: establishing, by a network node associated with an operator network of a first type of wireless communications, a connection to a UE configured for communications via the first type of wireless communications and a second type of wireless communications; establishing a bearer over the connection; and sending data associated with the bearer to an access point associated with the second type of wireless communications for transmission to the UE, wherein the data is associated with a traffic characteristic for transmission via the bearer, and wherein the data is transmitted by the access point to the UE according to an access category for the second type of wireless communications that is mapped from the traffic characteristic.
Aspect 27: The method of aspect 26, wherein sending the data associated with the bearer to the access point comprises mapping the traffic characteristic to the access category for the second type of wireless communications.
Aspect 28: The method of aspect 27, wherein sending the data associated with the bearer to the access point comprises encapsulating the data in a packet, wherein a header of the packet comprises the access category.
Aspect 29: The method of any of aspects 26 through 28, wherein sending the data associated with the bearer to the access point comprises appending the traffic characteristic to the data associated with the bearer.
Aspect 30: The method of any of aspects 26 through 29, wherein the traffic characteristic comprises an identifier of the bearer, at least one logical channel associated with the bearer, a quality of service profile of the bearer, an access class of the UE, or an establishment cause of the connection.
Aspect 31: An apparatus for wireless communication, comprising a processor; memory coupled with the processor; and instructions stored in the memory and executable by the processor to cause the apparatus to perform a method of any of aspects 1 through 18.
Aspect 32: An apparatus for wireless communication, comprising at least one means for performing a method of any of aspects 1 through 18.
Aspect 33: A non-transitory computer-readable medium storing code for wireless communication, the code comprising instructions executable by a processor to perform a method of any of aspects 1 through 18.
Aspect 34: An apparatus for wireless communication, comprising a processor; memory coupled with the processor; and instructions stored in the memory and executable by the processor to cause the apparatus to perform a method of any of aspects 19 through 25.
Aspect 35: An apparatus for wireless communication, comprising at least one means for performing a method of any of aspects 19 through 25.
Aspect 36: A non-transitory computer-readable medium storing code for wireless communication, the code comprising instructions executable by a processor to perform a method of any of aspects 19 through 25.
Aspect 37: An apparatus comprising a processor; memory coupled with the processor; and instructions stored in the memory and executable by the processor to cause the apparatus to perform a method of any of aspects 26 through 30.
Aspect 38: An apparatus comprising at least one means for performing a method of any of aspects 26 through 30.
Aspect 39: A non-transitory computer-readable medium storing code the code comprising instructions executable by a processor to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
establish, by a user equipment (UE), a first connection with a node of an operator network via an access point, wherein the operator network is associated with a first type of wireless communications and the access point is associated with a second type of wireless communications, and wherein the access point is selected from a set of access points based at least in part on the operator network and information associating the operator network with the access point; and
communicate with the node of the operator network via the access point based at least in part on establishing the first connection with the node of the operator network.

2. The apparatus of claim 1, wherein the instructions are further executable by the processor to cause the apparatus to:
transmit, from the UE to the access point, an address associated with the node of the operator network for control plane termination for the UE for the first type of wireless communications.

3. The apparatus of claim 1, wherein the UE is configured with respective sets of identifiers associated with the second type of wireless communications for each of a plurality of operator networks.

4. The apparatus of claim 3, wherein the instructions are further executable by the processor to cause the apparatus to:
receive a configuration message from the node of the operator network comprising at least one updated set of identifiers for the respective sets of identifiers.

5. The apparatus of claim 4, wherein the configuration message is received from a base station associated with the first type of wireless communications or the access point.

6. The apparatus of claim 1, wherein the instructions are further executable by the processor to cause the apparatus to:
receive, from the access point, system information associating the operator network and the access point.

7. The apparatus of claim 6, wherein establishing the first connection with the node is based at least in part on receiving the system information.

8. The apparatus of claim 6, wherein the system information comprises an indicator of a duration for a system information modification period or a starting time for the system information modification period, and the instructions are further executable by the processor to cause the apparatus to:
monitor for updated system information from the access point based at least in part on the indicator.

9. The apparatus of claim 6, wherein the system information comprises an indicator of a modification time for the system information, and the instructions are further executable by the processor to cause the apparatus to:
monitor for updated system information from the access point based at least in part on the indicator.

10. The apparatus of claim 6, wherein the instructions are further executable by the processor to cause the apparatus to:
receive second system information from a base station associated with the operator network; and
establish a second connection with the base station based at least in part on the system information or the second system information.

11. The apparatus of claim 10, wherein the instructions to establish the second connection are executable by the processor to cause the apparatus to:
select one of the system information or the second system information for the second connection based at least in part on a link priority for receiving system information.

12. The apparatus of claim 10, wherein the instructions to establish the second connection are executable by the processor to cause the apparatus to:
overwrite a portion of the system information based at least in part on the second system information.

13. The apparatus of claim 1, wherein the instructions are further executable by the processor to cause the apparatus to:
receive a broadcast message from the access point, the broadcast message comprising a paging message associated with the first type of wireless communications; and
respond to the paging message based at least in part on decoding the paging message.

14. The apparatus of claim 13, wherein the instructions to respond to the paging message are executable by the processor to cause the apparatus to:
transmit a packet comprising an encapsulated paging response message to the node of the operator network via the access point or transmitting a paging response message to a base station associated with the operator network.

15. The apparatus of claim 14, wherein the instructions are further executable by the processor to cause the apparatus to:
determine whether to transmit the packet comprising the encapsulated paging response message to the access point or to transmit the paging response message to the base station based at least in part on an access node priority for responding to the paging message, a link quality of the first connection, a channel quality of a channel between the UE and the base station, or a combination thereof.

16. The apparatus of claim 1, wherein the instructions are further executable by the processor to cause the apparatus to:
establish a second connection to a base station associated with the operator network;
establish a bearer associated with a traffic characteristic over the second connection; and
perform a channel access procedure for a channel associated with the second type of wireless communications for communicating data to the access point via the first connection based at least in part on an access category of the second type of wireless communications, the access category determined based at least in part on the traffic characteristic and a mapping rule between the traffic characteristic and the access category.

17. The apparatus of claim 16, wherein the traffic characteristic comprises information an identifier of the bearer, at least one logical channel associated with the bearer, a quality of service profile of the bearer, an access class of the UE, or an establishment cause of the second connection.

18. The apparatus of claim 1, wherein the instructions are further executable by the processor to cause the apparatus to:
receive, from the access point, an indicator of one or more operator networks supported by the access point for control plane communications associated with the first type of wireless communications, wherein connecting to the access point is based at least in part on receiving the indicator of one or more operator networks comprising the operator network.

19. An apparatus for wireless communication, comprising:
a processor;
memory coupled with the processor; and
instructions stored in the memory and executable by the processor to cause the apparatus to:
encapsulating, by a network node associated with an operator network of a first type of wireless communications, a paging message for a user equipment (UE) configured for communications via the first type of wireless communications and a second type of wireless communications;
send, by the network node, a packet comprising the encapsulated paging message to an access point associated with the second type of wireless communications; and
receive, by the network node, a paging response message from the UE.

20. The apparatus of claim 19, wherein the instructions to encapsulate the paging message are executable by the processor to cause the apparatus to:
set a destination address of the packet to an indicator that indicates to the access point to broadcast the packet.

21. The apparatus of claim 19, wherein the instructions to encapsulate the paging message are executable by the processor to cause the apparatus to:
set a source address of the packet to an address of the network node.

22. The apparatus of claim 19, wherein the instructions to encapsulate the paging message are executable by the processor to cause the apparatus to:
send an address of the UE to the access point with the packet.

23. The apparatus of claim 19, wherein the instructions to encapsulate the paging message are executable by the processor to cause the apparatus to:
set a destination address of the packet to an address of the UE.

24. The apparatus of claim 23, wherein the instructions to encapsulate the paging message are executable by the processor to cause the apparatus to:
obtain the address of the UE from a core node of the first type of wireless communications or from a stored context associated with the UE.

25. The apparatus of claim 19, wherein the instructions are further executable by the processor to cause the apparatus to:
determine to send the encapsulated paging message to the access point based at least in part on a predetermined paging policy, a paging policy received from a core node of the first type of wireless communications, a failure to receive a paging response from the UE after transmitting a prior paging message to the UE over a cell associated with the first type of wireless communications, a category of the UE, comparing a discontinuous reception cycle value associated with the UE and a threshold, a connection state of the UE, a characteristic of a protocol data unit comprising data associated with a paging request received from the core node, a quality of service of the data associated with the paging request, receiving an address of the UE in the paging request, or a combination thereof.

26. An apparatus, comprising:
a processor;
memory coupled with the processor; and
instructions stored in the memory and executable by the processor to cause the apparatus to:
establish, by a network node associated with an operator network of a first type of wireless communications, a connection to a user equipment (UE) configured for communications via the first type of wireless communications and a second type of wireless communications;
establish a bearer over the connection; and
send data associated with the bearer to an access point associated with the second type of wireless communications for transmission to the UE, wherein the data is associated with a traffic characteristic for transmission via the bearer, and wherein the data is transmitted by the access point to the UE according to an access category for the second type of wireless communications that is mapped from the traffic characteristic.

27. The apparatus of claim 26, wherein the instructions to send the data associated with the bearer to the access point are executable by the processor to cause the apparatus to:
map the traffic characteristic to the access category for the second type of wireless communications.

28. The apparatus of claim 27, wherein the instructions to send the data associated with the bearer to the access point are executable by the processor to cause the apparatus to:
encapsulate the data in a packet, wherein a header of the packet comprises the access category.

29. The apparatus of claim 26, wherein the instructions to send the data associated with the bearer to the access point are executable by the processor to cause the apparatus to:
append the traffic characteristic to the data associated with the bearer.

30. The apparatus of claim 26, wherein the traffic characteristic comprises an identifier of the bearer, at least one logical channel associated with the bearer, a quality of service profile of the bearer, an access class of the UE, or an establishment cause of the connection.
